(19) United States
(12) Patent Application Publication
(10) Pub. No.: US 2023/0142670 A1
(43) Pub. Date: May 11, 2023

(54) ENERGY-EFFICIENT AUTONOMOUS RESOURCE SELECTION FOR NR V2X SIDELINK COMMUNICATION

(71) Applicant: Fraunhofer-Gesellschaft zur Foerderung der angewandten Forschung e.V., Munich (DE)

(72) Inventors: Dariush MOHAMMAD SOLEYMANI, Erlangen (DE); Martin LEYH, Erlangen (DE); Elke ROTH-MANDUTZ, Erlangen (DE); Shubhangi BHADAURIA, Erlangen (DE); Mehdi HAROUNABADI, Erlangen (DE); Dietmar LIPKA, Erlangen (DE); Bernhard NIEMANN, Erlangen (DE)

(21) Appl. No.: 18/066,504

(22) Filed: Dec. 15, 2022

Related U.S. Application Data
(63) Continuation of application No. PCT/EP2021/066681, filed on Jun. 18, 2021.

(30) Foreign Application Priority Data
Jun. 19, 2020 (EP) 20181145.2

(51) Int. Cl. H04W 72/02; H04W 72/0446; H04W 72/0453; H04W 72/56

(52) U.S. Cl. CPC H04W 72/02; H04W 72/0446; H04W 72/0453; H04W 72/56

(57) ABSTRACT

A Transceiver [e.g., VRU-UE, P-UE, V-UE] of a wireless communication network is configured to communicate in a sidelink communication [e.g. NR V2X Mode2]. The transceiver is configured to select, for said sidelink communication, candidate resources [e.g. a set of candidate resources or candidate resource elements] out of resources of the sidelink communication [e.g., sub-channels, a resource pool or a bandwidth part] by use of a radio resource selection strategy [e.g. random selection without sensing; partial sensing based resource selection, where partial sensing is performed after resource selection is triggered, predictive resource selection; preemption limited to required resources]; and to adapt radio resource selection strategy dependent at least one parameter out of:
battery level and/or battery type of the transceiver;
QoS or priority of the packet to be transmitted;
Load constraints [e.g. network load (e.g. congestion), resource pool(s); usage, channel load (e.g. CBR)];
Bandwidth part.

### CROSS-REFERENCES TO RELATED APPLICATIONS

This application is a continuation of copending International Application No. PCT/EP2021/066681, filed Jun. 18, 2021, which is incorporated herein by reference in its entirety, and additionally claims priority from European Application No. EP 20 181 145.2, filed Jun. 19, 2020, which is incorporated herein by reference in its entirety.

### BACKGROUND OF THE INVENTION

The present application concerns the field of wireless communication systems and networks, more specifically to transceivers enabling power savings for battery operated UEs when operated in an autonomous or network controlled resource selection mode. Embodiments relate to leveraging the current resource selection strategies to maximize the energy efficiency of a user with a limited battery power.

FIG. 1a is a schematic representation of an example of a terrestrial wireless network 100 including, as is shown in FIG. 1aa, a core network 102 and one or more radio access networks RAN₁, RAN₂, . . . RAN_{N}. FIG. 1ab is a schematic representation of an example of a radio access network RAN_{D} that may include one or more base stations gNB₁ to gNB₅, each serving a specific area surrounding the base station schematically represented by respective cells 106₁ to 106₅. The base stations are provided to serve users within a cell. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT devices which connect to a base station or to a user. The mobile devices or the IoT devices may include physical devices, ground based vehicles, such as robots or cars, aerial vehicles, such as manned or unmanned aerial vehicles (UAVs), the latter also referred to as drones, buildings and other items or devices having embedded therein electronics, software, sensors, actuators, or the like as well as network connectivity that enables these devices to collect and exchange data across an existing network infrastructure. FIG. 1ab) shows an exemplary view of five cells, however, the RANₙ may include more or less such cells, and RANₙ may also include only one base station. FIG. 1ab) shows two users UE₁ and UE₂, also referred to as user equipment, UE, that are in cell 106₂ and that are served by base station gNB₂. Another user UE₃ is shown in cell 106₄ which is served by base station gNB₄. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. Further, FIG. 1ab) shows two IoT devices 110₁ and 110₂ in cell 106₄, which may be stationary or mobile devices. The IoT device 110₁ accesses the wireless communication system via the base station gNB₄ to receive and transmit data as schematically represented by arrow 112₁. The IoT device 110₂ accesses the wireless communication system via the user UE₃ as is schematically represented by arrow 112₂. The respective base station gNB₁ to gNB₅ may be connected to the core network 102, e.g. via the S1 interface, via respective backhaul links 114₁ to 114₅, which are schematically represented in FIG. 1ab) by the arrows pointing to “core”. The core network 102 may be connected to one or more external networks. Further, some or all of the respective base station gNB₁ to gNB₅ may connected, e.g. via the S1 or X2 interface or the XN interface in NR, with each other via respective backhaul links 116₁ to 116₅, which are schematically represented in FIG. 1ab) by the arrows pointing to “gNBs”.

For data transmission a physical resource grid may be used. The physical resource grid may comprise a set of resource elements to which various physical channels and physical signals are mapped. For example, the physical channels may include the physical downlink, uplink and sidelink shared channels (PDSCH, PUSCH, PSSCH) carrying user specific data, also referred to as downlink, uplink and sidelink payload data, the physical broadcast channel (PBCH) carrying for example a master information block (MIB) and a system information block (SIB), the physical downlink, uplink and sidelink control channels (PDCCH, PUCCH, PSSCH) carrying for example the downlink control information (DCI), the uplink control information (UCI) and the sidelink control information (SCI). For the uplink, the physical channels may further include the physical random access channel (PRACH or RACH) used by UEs for accessing the network once a UE synchronized and obtained the MIB and SIB. The physical signals may comprise reference signals or symbols (RS), synchronization signals and the like. The resource grid may comprise a frame or radio frame having a certain duration in the time domain and having a given bandwidth in the frequency domain. The frame may have a certain number of subframes of a predefined length, e.g. 1 ms. Each subframe may include one or more slots of 12 or 14 OFDM symbols depending on the cyclic prefix (CP) length. A frame may also consist of a smaller number of OFDM symbols, e.g. when utilizing shortened transmission time intervals (sTTI) or a mini-slot/non-slot-based frame structure comprising just a few OFDM symbols.

The wireless communication system may be any single-tone or multicarrier system using frequency-division multiplexing, like the orthogonal frequency-division multiplexing (OFDM) system, the orthogonal frequency-division multiple access (OFDMA) system, or any other IFFT-based signal with or without CP, e.g. DFT-s-OFDM. Other waveforms, like non-orthogonal waveforms for multiple access, e.g. filter-bank multicarrier (FBMC), generalized frequency division multiplexing (GFDM) or universal filtered multi carrier (UFMC), may be used. The wireless communication system may operate, e.g., in accordance with the LTE-Advanced pro standard or the NR (5G), New Radio, standard.

The wireless network or communication system depicted in FIG. 1a may by a heterogeneous network having distinct overlaid networks, e.g., a network of macro cells with each macro cell including a macro base station, like base station gNB₁ to gNB₅, and a network of small cell base stations (not shown in FIG. 1a), like femto or pico base stations.

In addition to the above described terrestrial wireless network also non-terrestrial wireless communication networks exist including spaceborne transceivers, like satellites, and/or airborne transceivers, like unmanned aircraft systems. The non-terrestrial wireless communication network or system may operate in a similar way as the terrestrial system described above with reference to FIG. 1a, for example in accordance with the LTE-Advanced Pro standard or the NR (5G), new radio, standard.

In mobile communication networks, for example in a network like that described above with reference to FIG. 1a, like an LTE or 5G/NR network, there may be UEs that communicate directly with each other over one or more sidelink (SL) channels, e.g., using the PC5 interface. UEs that communicate directly with each other over the sidelink may include vehicles communicating directly with other vehicles (V2V communication), vehicles communicating with other entities of the wireless communication network (V2X communication), for example roadside entities, like traffic lights, traffic signs, or pedestrians. Other UEs may not be vehicular related UEs and may comprise any of the above-mentioned devices. Such devices may also communicate directly with each other (D2D communication) using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 1a. This is referred to as an “in-coverage” scenario. Another scenario is referred to as an “out-of-coverage”scenario. It is noted that “out-of-coverage” does not mean that the two UEs are not within one of the cells depicted in FIG. 1a, rather, it means that these UEs
may not be connected to a base station, for example, they are not in an RRC connected state, so that the UEs do not receive from the base station any sidelink resource allocation configuration or assistance, and/or
may be connected to the base station, but, for one or more reasons, the base station may not provide sidelink resource allocation configuration or assistance for the UEs, and/or
may be connected to the base station that may not support NR V2X services, e.g. GSM, UMTS, LTE base stations.

When considering two UEs directly communicating with each other over the sidelink, e.g. using the PC5 interface, one of the UEs may also be connected with a BS, and may relay information from the BS to the other UE via the sidelink interface. The relaying may be performed in the same frequency band (in-band-relay) or another frequency band (out-of-band relay) may be used. In the first case, communication on the Uu and on the sidelink may be decoupled using different time slots as in time division duplex, TDD, systems.

FIG. 1b is a schematic representation of an in-coverage scenario in which two UEs directly communicating with each other are both connected to a base station. The base station gNB has a coverage area that is schematically represented by the circle 200 which, basically, corresponds to the cell schematically represented in FIG. 1a. The UEs directly communicating with each other include a first vehicle 202 and a second vehicle 204 both in the coverage area 200 of the base station gNB. Both vehicles 202, 204 are connected to the base station gNB and, in addition, they are connected directly with each other over the PC5 interface. The scheduling and/or interference management of the V2V traffic is assisted by the gNB via control signaling over the Uu interface, which is the radio interface between the base station and the UEs. In other words, the gNB provides SL resource allocation configuration or assistance for the UEs, and the gNB assigns the resources to be used for the V2V communication over the sidelink. This configuration is also referred to as a mode 1 configuration in NR V2X or as a mode 3 configuration in LTE V2X.

FIG. 1c is a schematic representation of an out-of-coverage scenario in which the UEs directly communicating with each other are either not connected to a base station, although they may be physically within a cell of a wireless communication network, or some or all of the UEs directly communicating with each other are to a base station but the base station does not provide for the SL resource allocation configuration or assistance. Three vehicles 206, 208 and 210 are shown directly communicating with each other over a sidelink, e.g., using the PC5 interface. The scheduling and/or interference management of the V2V traffic is based on algorithms implemented between the vehicles. This configuration is also referred to as a mode 2 configuration in NR V2X or as a mode 4 configuration in LTE V2X. As mentioned above, the scenario in FIG. 1c which is the out-of-coverage scenario does not necessarily mean that the respective mode 2 UEs (in NR) or mode 4 UEs (in LTE) are outside of the coverage 200 of a base station, rather, it means that the respective mode 2 UEs (in NR) or mode 4 UEs (in LTE) are not served by a base station, are not connected to the base station of the coverage area, or are connected to the base station but receive no SL resource allocation configuration or assistance from the base station. Thus, there may be situations in which, within the coverage area 200 shown in FIG. 1b, in addition to the NR mode 1 or LTE mode 3 UEs 202, 204 also NR mode 2 or LTE mode 4 UEs 206, 208, 210 are present.

In V2X applications, an available power of the so-called Vulnerable Road Users (VRUs), e.g. pedestrians, cyclists, stroller, etc., is limited, since these VRUs, such as pedestrian UEs (P-UEs), are usually depending on their UEs battery only, different to vehicle mounted vehicular UEs (V-UE). Therefore, for P-UEs battery saving for V2X communication is essential to guarantee continuous V2X application support.

It is noted that the information in the above section is only for enhancing the understanding of the background of the invention and therefore it may contain information that does not form conventional technology that is already known to a person of ordinary skill in the art.

Starting from the above, there is a need for improvements or enhancements with respect to power savings for battery operated UEs.

### SUMMARY

An embodiment may have a transceiver of a wireless communication network, the transceiver being configured to communicate in a sidelink communication; wherein the transceiver is configured to select, for said sidelink communication, candidate resources out of resources of the sidelink communication by use of a radio resource selection strategy; and wherein the transceiver is configured to adapt a radio resource selection strategy dependent at least one parameter out of:
battery level and/or battery type of the transceiver;
QoS or priority of the packet to be transmitted;
Load constraints, resource pool; usage, channel load;
Bandwidth part;
resource pool;

characterized in that (i) the transceiver is instructed to select candidate resources randomly from a defined portion of a pre-configured or configured resource pool or a separate specific resource pool or a pre-configured or configured part of a resource pool or to use random resource selection in any type of resource pool; wherein in case of using of radio resource selection based on random resource selection the adaption of a radio resource selection strategy comprises an adaption with regard to at least one parameter out of partial sensing parameters;
traffic arrivals/flags for triggering the partial sensing;
sensing time instances K;
sensing duration ts;
pr, _pt, where pr is the priority value that is received in in the control information, and pt is the priority of transmission that depends on the application requirements; packet delay budget;
number of subchannels;
number of subframes with resource reservations for retransmission or transmission; and/or
resource pool.

Another embodiment may have a transceiver of a wireless communication network, the transceiver being configured to communicate in a sidelink communication; wherein the transceiver is configured to select, for said sidelink communication, candidate resources out of resources of the sidelink communication by use of a radio resource selection strategy; and wherein the transceiver is configured to adapt a radio resource selection strategy dependent at least one parameter out of:
battery level and/or battery type of the transceiver;
QoS or priority of the packet to be transmitted;
Load constraints, resource pool; usage, channel load;
Bandwidth part;
resource pool;

characterized in that (ii) partial sensing is performed or continuously performed immediate after triggering or after triggering with a delay offset; and/or wherein partial sensing is performed or continuously performed till a first slots of set of candidate slots considering processing time; wherein in case of using of radio resource selection based on partial sensing the adaption of a radio resource selection strategy comprises an adaption with regard to at least one parameter out of
partial sensing parameters;
traffic arrivals/flags for triggering the partial sensing;
sensing time instances K;
sensing duration ts;
pr, _pt, where pr is the priority value that is received in in the control information, and pt is the priority of transmission that depends on the application requirements;
packet delay budget;
number of subchannels;
number of subframes with resource reservations for retransmission or transmission; and/or
resource pool.

Another embodiment may have a transceiver of a wireless communication network, the transceiver being configured to communicate in a sidelink communication; wherein the transceiver is configured to select, for said sidelink communication, candidate resources out of resources of the sidelink communication by use of a radio resource selection strategy; and wherein the transceiver is configured to adapt a radio resource selection strategy dependent at least one parameter out of:
battery level and/or battery type of the transceiver;
QoS or priority of the packet to be transmitted;
Load constraints;
Bandwidth part;
resource pool;

characterized in that (i) the candidate resources are calculated by considering prediction functionality; or wherein the candidate resources are calculated by considering prediction functionality and wherein the functionality prediction is based on a geographical location of nearby transceivers.

Another embodiment may have a transceiver of a wireless communication network, the transceiver being configured to communicate in a sidelink communication; wherein the transceiver is configured to select, for said sidelink communication, candidate resources out of resources of the sidelink communication by use of a radio resource selection strategy; and wherein the transceiver is configured to adapt a radio resource selection strategy dependent at least one parameter out of:
battery level and/or battery type of the transceiver;
QoS or priority of the packet to be transmitted;
Load constraints;
Bandwidth part;
resource pool;

characterized in that (ii) the candidate resources are calculated by considering prediction functionality; or wherein the candidate resources are calculated by considering prediction functionality and wherein the functionality prediction is based on a geographical location of nearby transceivers, wherein the transceiver is configured to predict resources of the nearby users approaching an area.

Another embodiment may have a transceiver of a wireless communication network, the transceiver being configured to communicate in a sidelink communication; wherein the transceiver is configured to select, for said sidelink communication, candidate resources out of resources of the sidelink communication by use of a radio resource selection strategy; and wherein the transceiver is configured to adapt a radio resource selection strategy dependent at least one parameter out of:
battery level and/or battery type of the transceiver;
QoS or priority of the packet to be transmitted;
Load constraints;
Bandwidth part;
resource pool;

characterized in that (iii) the transceiver is configured to use a partial preemption of reserved candidate resources in the frequency domain and/or time domain; or wherein the transceiver is configured to use a partial preemption of reserved candidate resources in the frequency domain and/or time domain when the preemption configured by the higher layer or when the preempting UE's subchannel size is smaller than the preempted UE thereof as per previous preemption procedure or wherein the transceiver is configured to use the remaining radio resource over time/frequency after a partial preemption or wherein the transceiver is configured by the higher layer signaling to use the remaining part of the preempted radio resource over time/frequency domain.

Another embodiment may have a vulnerable road user equipment, VRU-UE, comprising a transceiver according to the invention.

Another embodiment may have a method for communicate in a sidelink communication using a transceiver of a wireless communication network, the method comprising: selecting, for said sidelink communication, candidate resources out of resources of the sidelink communication by use of a radio resource selection strategy; and adapting a radio resource selection strategy dependent at least one parameter out of:
battery level and/or battery type of the transceiver;
QoS or priority of the packet to be transmitted;
Load constraints;
Bandwidth part;
resource pool;

characterized in that (i) the transceiver is instructed to select candidate resources randomly from a defined portion of a preconfigured or configured resource pool or a separate specific resource pool or a preconfigured or configured part of a resource pool or to use random resource selection in any type of resource pool; and in that the wherein in case of using of radio resource selection based on random selection the adaption of a radio resource selection strategy comprises an adaption with regard to at least out of partial sensing parameters;
traffic arrivals/flags for triggering the partial sensing;
sensing time instances K;
sensing duration ts;
pr, _pt, where pr is the priority value that is received in in the control information, and pt is the priority of transmission that depends on the application requirements;
packet delay budget;
number of subchannels;
number of subframes with resource reservations for retransmission or transmission; and/or
resource pool.

Another embodiment may have a method for communicate in a sidelink communication using a transceiver of a wireless communication network, the method comprising: selecting, for said sidelink communication, candidate resources out of resources of the sidelink communication by use of a radio resource selection strategy; and adapting a radio resource selection strategy dependent at least one parameter out of:

battery level and/or battery type of the transceiver;
QoS or priority of the packet to be transmitted;
Load constraints;
Bandwidth part;
resource pool;

characterized in that (ii) partial sensing is performed or continuously performed immediate after triggering or after triggering with a delay offset; and/or wherein partial sensing is performed or continuously performed till a first slots of set of candidate slots considering processing time; and in that the wherein in case of using of radio resource selection based on partial sensing the adaption of a radio resource selection strategy comprises an adaption with regard to at least one parameter out of
partial sensing parameters;
traffic arrivals/flags for triggering the partial sensing;
sensing time instances K;
sensing duration ts;
pr, _pt, where pr is the priority value that is received in in the control information, and pt is the priority of transmission that depends on the application requirements;
packet delay budget;
number of subchannels;
number of subframes with resource reservations for retransmission or transmission; and/or
resource pool.

Another embodiment may have a method for communicate in a sidelink communication using a transceiver of a wireless communication network, the method comprising: selecting, for said sidelink communication, candidate resources out of resources of the sidelink communication by use of a radio resource selection strategy; and adapting a radio resource selection strategy dependent at least one parameter out of:
battery level and/or battery type of the transceiver;
QoS or priority of the packet to be transmitted;
Load constraints;
Bandwidth part;
resource pool;

characterized in that (i) the candidate resources are calculated by considering prediction functionality; or wherein the candidate resources are calculated by considering prediction functionality and wherein the functionality prediction is based on a geographical location of nearby transceivers.

Another embodiment may have a method for communicate in a sidelink communication using a transceiver of a wireless communication network, the method comprising: selecting, for said sidelink communication, candidate resources out of resources of the sidelink communication by use of a radio resource selection strategy; and adapting a radio resource selection strategy dependent at least one parameter out of:
battery level and/or battery type of the transceiver;
QoS or priority of the packet to be transmitted;
Load constraints;
Bandwidth part;
resource pool;

characterized in that (ii) the candidate resources are calculated by considering prediction functionality; or wherein the candidate resources are calculated by considering prediction functionality and wherein the functionality prediction is based on a geographical location of nearby transceivers, wherein the transceiver is configured to predict resources of the nearby users approaching an area.

Another embodiment may have a method for communicate in a sidelink communication using a transceiver of a wireless communication network, the method comprising: selecting, for said sidelink communication, candidate resources out of resources of the sidelink communication by use of a radio resource selection strategy; and adapting a radio resource selection strategy dependent at least one parameter out of:
battery level and/or battery type of the transceiver;
QoS or priority of the packet to be transmitted;
Load constraints;
Bandwidth part;
resource pool;

characterized in that (iii) the transceiver is configured to use a partial preemption of reserved candidate resources in the frequency domain and/or time domain; or wherein the transceiver is configured to use a partial preemption of reserved candidate resources in the frequency domain and/or time domain when the preemption configured by the higher layer or when the preempting UE's subchannel size is smaller than the preempted UE thereof as per previous preemption procedure or wherein the transceiver is configured to use the remaining radio resource over time/frequency after a partial preemption or wherein the transceiver is configured by the higher layer signaling to use the remaining part of the preempted radio resource over time/frequency domain.

Another embodiment may have a non-transitory digital storage medium having a computer program stored thereon to perform the method for communicate in a sidelink communication using a transceiver of a wireless communication network, the method comprising: selecting, for said sidelink communication, candidate resources out of resources of the sidelink communication by use of a radio resource selection strategy; and adapting a radio resource selection strategy dependent at least one parameter out of:
battery level and/or battery type of the transceiver;
QoS or priority of the packet to be transmitted;
Load constraints;
Bandwidth part;
resource pool;

characterized in that (i) the transceiver is instructed to select candidate resources randomly from a defined portion of a preconfigured or configured resource pool or a separate specific resource pool or a preconfigured or configured part of a resource pool or to use random resource selection in any type of resource pool; and in that the wherein in case of using of radio resource selection based on random selection the adaption of a radio resource selection strategy comprises an adaption with regard to at least out of partial sensing parameters;
traffic arrivals/flags for triggering the partial sensing;
sensing time instances K;
sensing duration ts;
pr, _pt, where pr is the priority value that is received in in the control information, and pt is the priority of transmission that depends on the application requirements;
packet delay budget;
number of subchannels;
number of subframes with resource reservations for retransmission or transmission; and/or
resource pool,

when said computer program is run by a computer.

### BRIEF DESCRIPTION OF THE DRAWINGS

Embodiments of the present invention will be detailed subsequently referring to the appended drawings, in which:

FIG. 1a shows a schematic representation of an example of a wireless communication system,

FIG. 1b is a schematic representation of an in-coverage scenario in which UEs directly communicating with each other are connected to a base station,

FIG. 1c is a schematic representation of an out-of-coverage scenario in which UEs directly communicating with each other receive no SL resource allocation configuration or assistance from a base station,

FIG. 2 shows an example of partial sensing in LTE V2X mode 4;

FIG. 3, 4 show schematically specific resource pool configuration for random selection, when subchannel size in a resource pool configured unequally and equally respectively,

FIG. 5 illustrate schematically partial sensing performed after triggering resource selection procedure,

FIG. 6, 7 are a schematic representations of predictive resource selection,

FIG. 8 is a schematic representation of partial preemption of already reserved sub-channel, and

FIG. 9 illustrate an implementation using a processor.

### DETAILED DESCRIPTION OF THE INVENTION

Embodiments of the present invention are now described in more detail with reference to the accompanying drawings in which the same or similar elements have the same reference signs assigned.

As indicated above, there is a problem to be solved is the high-power consumption of the so-called Vulnerable Road Users (VRUs), e.g. pedestrians, cyclists, stroller, e.t.c. using V2X applications. These pedestrian UEs (P-UEs) representing here to all VRU UEs are usually depending on their UEs battery only, different to vehicle mounted vehicular UEs (V-UE). Therefore, for P-UEs battery saving for V2X communication is essential to guarantee continuous V2X application support.

The partial sensing that currently planned to be introduced for NR Sidelink for Rel-17 as per Work Item description [8] using LTE as baseline. The partial sensing for NR Sidelink has to be adapted with respect to NR specifics (e.g., support of different numerologies/sub-carrier spacings SCS, Bandwidth Parts (BWP), NR Sidelink waveform specifics), as well as the best possible energy saving mechanism for P-UEs with minimum impact on the selection of the most appropriate radio resources.

In the resource selection strategy, transmission parameters, e.g., waveform, Modulation Coding Scheme (MCS), Tx power, and the number of sub-channels seem to be canonical parameters that play an essential role in the power consumption and the sum rate of the vulnerable users.

Generally, the resource selection strategy can also influence the transmission parameters and sum rate. For instance, when two nearby users share a radio resource, the received signal strength may deteriorate due to interference if the receivers are also too close, which results in increasing the packet errors at the receiver(s). The packet errors bring about the packet retransmission(s) in uni-cast and multi-cast communication, which further degrades the UE's sum-rate and consequently, more power consumption by the UE.

Therefore, the resource selection strategy and transmission parameters, e.g., Tx power, that have been discussed in NR Sidelink for V2X (as per Work Item description [8]) should be enhanced taking into consideration the limited battery life of P-UEs.

Thus, embodiments aim to leverage the current resource selection strategies to maximize the energy efficiency of a user with a limited battery power.

The problem to be solved may also be used in context or (directly) related to the Rel-17 Work Item “New WID on NR sidelink enhancement” in [6], where the second objective states:

“2. Resource allocation enhancement:
Specify resource allocation to reduce power consumption of the UEs [RAN1, RAN2]
Baseline is to introduce the principle of Rel-14 LTE sidelink random resource selection and partial sensing to Rel-16 NR sidelink resource allocation mode 2.

Note: Taking Rel-14 as the baseline does not preclude introducing a new solution to reduce power consumption for the cases where the baseline cannot work properly.”

In general, it is the objective of the present invention to provide an improved approach for a resource selection strategy enhancement to reduce the VRU-UEs power consumption.

Below some State of the Art solutions together with adaptions according to embodiments will be discussed:

In LTE V2X Mode 4 [1], the following radio resource selection procedures are undertaken:
Random radio resource selection
Sensing-based radio resource selection
Partial sensing-based radio resource selection

If the random radio resource selection is configured by higher layer signaling, a user will transmit on a single carrier within a resource pool of a carrier, which is configured by the base station (eNB/gNB). A set of radio resources is selected and sent to a higher layer, wherein the higher layer can be an application, session, transport, RRC, RLC, PDCP, or MAC layer. This procedure is as follows:
1. A candidate subframe, Rxy, is a set of contiguous sub-channels, x+j, in a subframe, t_m, where j=0, . . . , L−1, is a set of contiguous sub-channels within the time interval [n+T1, n+T2], the time stamp n is the packet arrival time. T1 and T2 are processing time and packet delay budget, respectively. T1 and T2 values depend on the UE implementation and should meet the following conditions:
   a. T1<=4 and T2_min (priority of TX)<=T2<=100, where the higher layer provides priority of TX, otherwise T2_min is set to 20.
2. A set of all candidate subframe resources is assumed in Sa, and an empty set of Sb is created.
3. The UE relocates a candidate subframe resource Rxy from set Sa into set Sb.
4. In case, a UE is configured by the higher layer to transmit on multiple carriers, the UE shall exclude a subframe resource Rxy from Sb, if the UE cannot support simultaneous transmission due to its limitation, or not support the corresponding carrier combination.
5. The UE shall send the Sb list to the higher layer.

The below table illustrates the determination of Pstep for sidelink transmission Mode 4.

| Confguration | Pstep |
|---|---|
| TDD configuration 0 | 60 |
| TDD configuration 1 | 40 |
| TDD configuration 2 | 20 |
| TDD configuration 3 | 30 |
| TDD configuration 4 | 20 |
| TDD configuration 5 | 10 |
| TDD configuration 6 | 50 |
| Others | 100 |

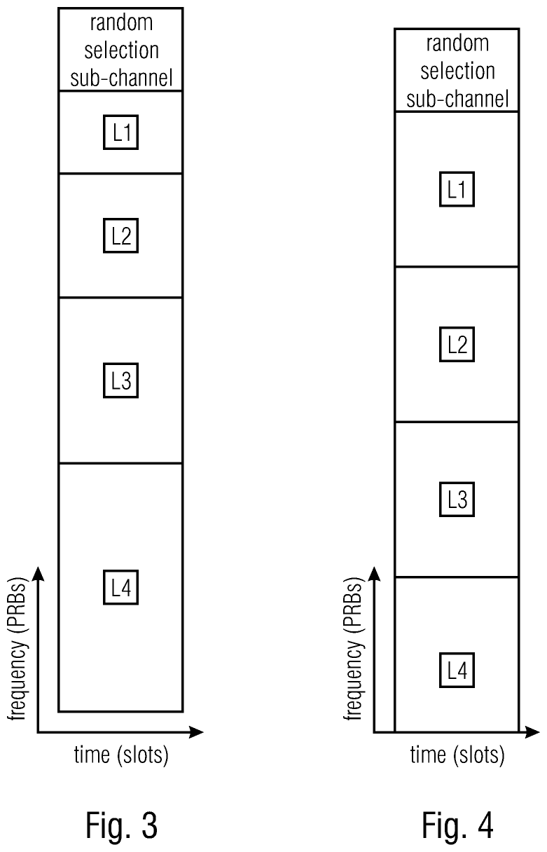

When the higher layer configures partial sensing, then the UE performs the candidate radio resource selection as follows [1, section 14.1.1.6]:
1. Candidate radio resources for data transmission Rxy is a set of contiguous sub-channels L with x+j subchannel in subframe t_m where j=1, . . . , L and the UE selects y subframes within the [n+T1,n+T2] wherein y depends on the UE implementation. The higher layer signaling configures T1, T2, their values depend on the UE implementation. T2 value is between T2 min(priotx) and 100 ms if the higher layer signaling configures T2 min, otherwise T2 min is 20 ms by default. Besides, the upper bound of T2 depends on the maximum delay that a packet is allowed to wait in the UE buffer before transmission. Note that y should fulfill the higher layer parameter minNumCandidateSF within Mtotal, wherein the Mtotal is a total number of subframe resources.
2. When the k-th bit of the higher layer signaling is toggled, the UE shall monitor all t_y−k*Pstep) subframe resources, where k is gapCandidatesensing with 10 bits which is configured by the higher layer signaling. Where Pstep is a step size between two consecutive sensing time instances that it is configured, as shown in Table 1.
3. FIG. 2 represents the sensing time instances monitored by a P-UE when partial sensing is configured.
4. The parameter Tha, b is set by the higher layer signaling as indicated in SL-ThresPSSCH-RSRP.
5. Sa is a list of all candidate radio resource subframes and Sb is an empty set.
6. The UE excludes any subframe resources from the set Sa that meet all of the following conditions:
   a. The UE decodes a SCI format 1 indicating the resource reservation and priority, i.e., ‘resource reservation’ and ‘priority’. The parameter priorx is derived from the “priority” field.
   b. Measured PSSCH-RSSP is higher than Th(priotx,priorx) value
   c. The UE received a SCI format 1 at subframe tm+q*Pstep*Prsvp_RX, indicating the number of reserved resources with a higher priority that overlaps with Rx,y+j*P′rsvp_TX where q=1, 2, . . . , Q and J=0, 1, . . . , Cresel−1. The value Q=1/Prsvp_RX if Prsvp_RX<1 and y−m<=Pstep*Prsvp_RX+Pstep and if ty is the last subframe of the Y subframes, Q=1.
7. If the number of identified candidate radio resource subframes in the set of Sa is smaller than 0.2*Mtotal, then the Th (a, b) in the step 3 is increased by 3 dB.
8. For the remaining Rxy subframe resources in the set Sa. The metric Exy is defined as average S-RSSI in subchannel x+k for k=0, . . . , L−1 in the subframe resource ty−Pstep*j.
9. The UE moves the candidate resources having the smallest Exy from Sa to Sb such that the number of available subframe resource in the Sb reaches to the 0.2*Mtotal.
10. In the case of multi carriers, the UE removes subframe resources Rxy from Sb when the UE does not support the multi-carriers feature.

The UE reports the set Sb to higher layers.

In NR V2X Mode 2 in Rel-16, LTE V2X Mode 4 was enhanced by supporting e.g. different V2X traffic types (e.g., aperiodic, periodic) and different cast communications, i.e., broadcast, unicast and groupcast. The following subsections detail the radio resource selection procedure in NR-V2X Mode 2 [2]:

The higher layer may request the UE to report the subframe resources considering some parameters, e.g., priority (received and transmit), configured resource pool, packet delay budget, radio resource reservation, that can be used by higher-layer for control or data transmission.

The UE considers the following parameters during the subframe resource selection process:
T2minSelectionWindow: the minimum time that is used in the resource selection window and configured by higher layers.
SL-ThresRSRP_pi_pj: RSRP threshold for the received priority pi in SCI format 0-1, and transmission priority pj configured by the higher layer.
RSforsensing: it determines that the RSRP in control or data channels is taken into consideration.
T0_Sensing_Window: it is the number of measured slots that are considered during the candidate resource selection process.
reservationPeriodAllowed

Besides, Prsvp_TX is a transmission reservation period, which can be converted to the logical slot, P′rsvp_tx, when it is needed.

Similar to LTE V2X Mode 4 [1], in NR V2X Mode 2 [2], the resource selection process is performed as follows:
1. The UE selects a slot Rxy for transmission, where it consists of L contiguous radio resources starting from x+j wherein j=0, 1 . . . L−1. The UE would select a slot with respect to the resource pool between [n+T1, n+T2], where T1 and T2 values are up to UE implementation, and T2 should be between T2 min and PDB time when T2 min is configured. Otherwise, it is set to the remaining PDB. Note that, Mtotal is the total available slot radio resources for the transmission.
2. The UE monitors the slots within the sensing window, as mentioned earlier.
3. Th(pi) is configured by the higher layer.
4. All radio resources comprise a set of Sa.
5. The UE excludes Rxy from Sa when the following conditions are met:
   a. The UE has not monitored the slot.
   b. SCI format 0-1 indicates that ‘Resource Reservation period’ is set, and no subchannels are available for a particular slot.
   c. SCI format 0-1 indicates that radio resources are reserved and priority value is higher than the transmission priority.
   d. Measured RSRP value is higher than Th (prior_RX) received in SCI format 0-1.
   e. When the ‘Resource Reservation Period’ field is set on the received SCI format 0-1 at the tm+q*P′rsvp_RX which overlaps with Rxy+jP′rsvp_TX where q=1, 2, . . . , Q and j=0, 1, 2, . . . , Cresel−1. Note that P′rsvp_RX is a logical slot that is obtained from Prsvp_RX and Q=Roof (Tscal/Prscvp_RX) if Rrsvp_RX<Tscal. Where Tscal is the remaining time to the packet delay budget. And n′<=m+P′rsvp_RX, where n=n′ when slot n belongs to the reserved transmission time period, otherwise it is the first slot after n in the range of configured transmission slots.
   f. When the number of candidate slot resources is less than 0.2*Mtotal, then Th(pi) is increased by 3 db and the resource selection procedure is initiated from Step 4.

The UE reports the Sa to the higher layers.

Bellow embodiments of the invention will be discussed:

Embodiments provide a transceiver, e.g., VRU-UE, P-UE, V-UE, of a wireless communication network, the transceiver being configured to communicate in a sidelink communication, e.g. NR V2X Mode2]. Here, the transceiver is configured to select, for said sidelink communication, candidate resources, e.g. a set of candidate resources or candidate resource elements, out of resources of the sidelink communication, e.g., sub-channels, a resource pool or a bandwidth part, by use of a radio resource selection strategy. Further, the transceiver is configured to adapt radio resource selection strategy dependent at least one parameter out of:
Battery level and/or battery type of the transceiver;
QoS or priority of the packet to be transmitted;
Load constraints, e.g. network load (e.g. congestion), resource pool(s); usage, channel load (e.g. CBR)];
Bandwidth part.

Resource selection strategy may be random selection without sensing (e.g. Random selection strategy on a specific resource pool), partial sensing based resource selection, where partial sensing is performed after resource selection is triggered/traffic arrival, predictive resource election, preemption limited to required resources (e.g. partial preemption of reserved radio resources).

The major benefit of this invention is the power reduction of VRU UEs performing resource allocation using V2X applications. Opposite to vehicular mounted UE connected to the vehicles power supply, power reduction for the VRU using battery-based UE is very important. This is also requested in the Rel-17 WI as one major objective.

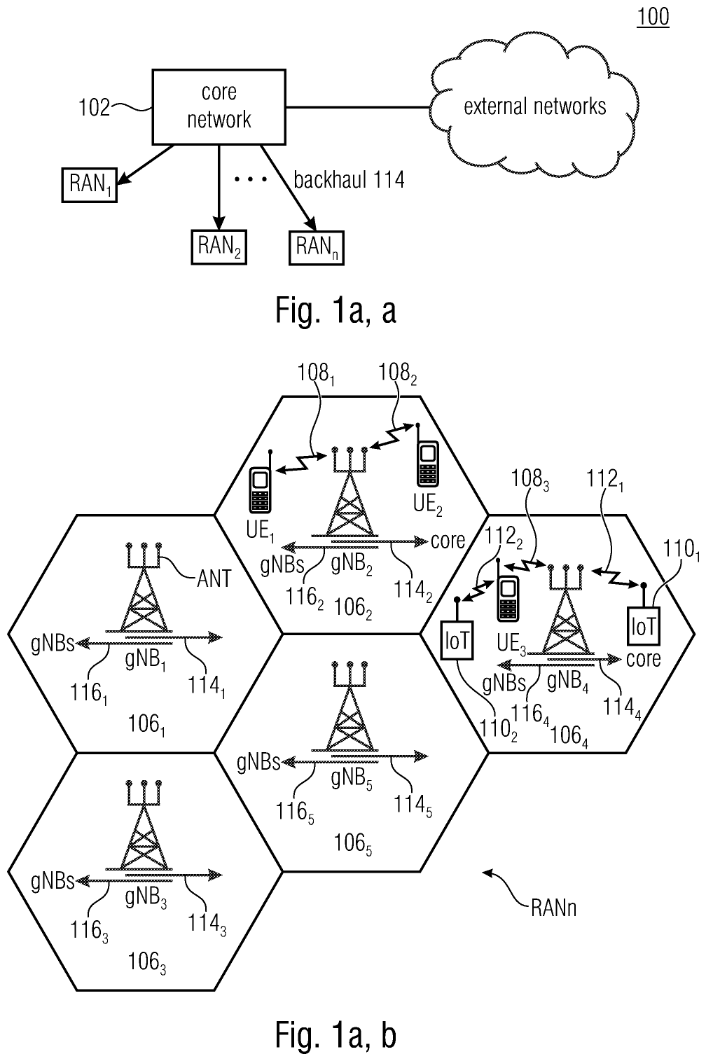

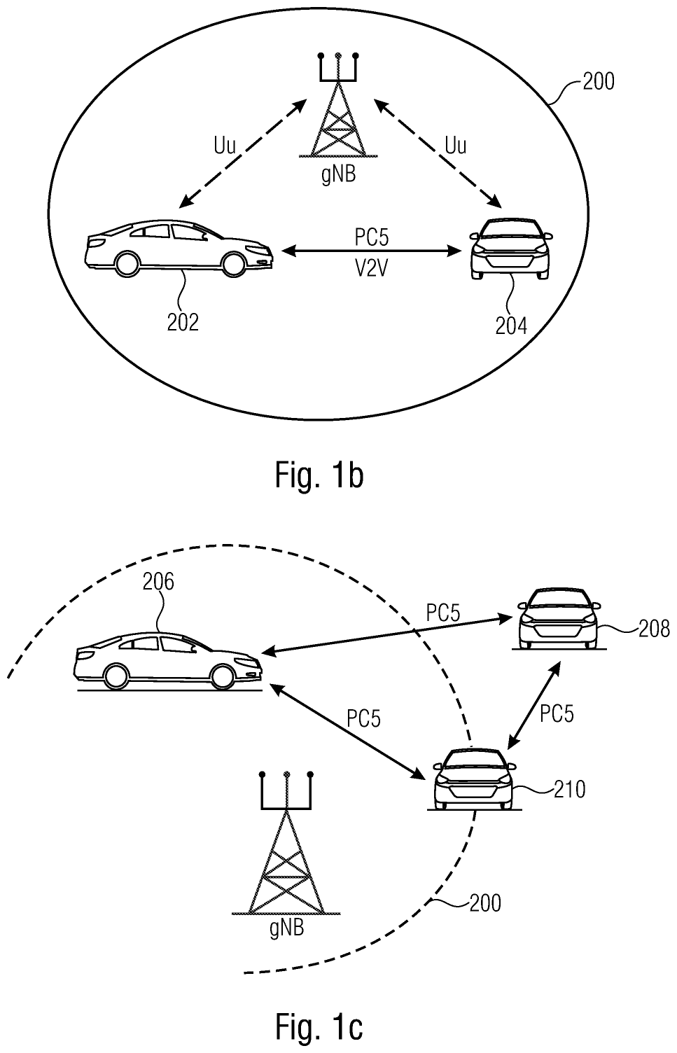

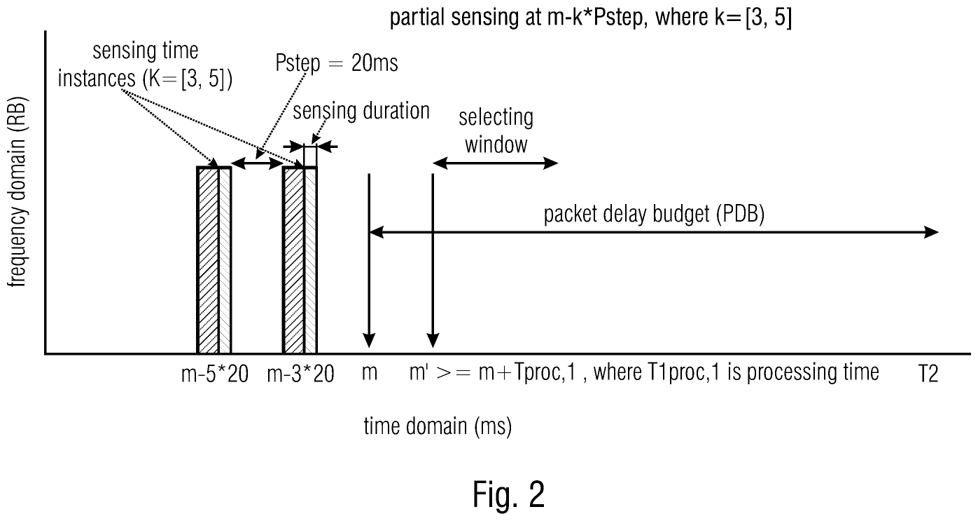

Embodiments of the present invention may be implemented in a wireless communication system as depicted in FIG. 1a, FIG. 1b, and FIG. 1c including base stations and users, like mobile terminals or IoT devices.

As explained in the SOTA, for LTE Mode 4, partial sensing is used by a user to reduce the energy consumption. With partial sensing, a UE will only have a partial knowledge of the resource occupancy that increases resource collisions due to wrong radio resource selection. Radio resource collisions in turn cause an increase in packet retransmission leading to more power consumption. To reduce the power consumption in NR V2X Mode 2, as stated in the WI description [6], this invention looks into the following approaches for resource selection:
The UE undertakes a random selection strategy without (partial) sensing.
Resource selection strategy when partial sensing is performed only after the radio resource selection is triggered.
Predictive resource selection strategy possibly combined with UE sensing information e.g. to reduce power consumption arising from data retransmission due to the selection of the resources with poor RSRP.
Preemption procedure: In Rel-16 a UE with higher priority transmission preempts the complete set of reserved radio resources from a UE with lower priority transmission. However, when the preempting UE's sub-channel size is smaller than that of the preempted UE, a part of preempted radio resources may not be used as explained in the preemption procedure in Rel 16.0.

Embodiments define different resource selection strategies for NR V2X Mode2 with the major objective to reduce the UE power consumption, but partially also to increase the capacity and reliability and reduce the latency. The proposed solutions should mainly apply to UEs with limited battery capacity, e.g. P-UEs, but may also apply to all other types of UEs, e.g. V-UEs. A UE, for example, of a vulnerable road user, adopts a radio resource selection strategy so as to reduce power consumption considering UE or network conditions, possibly considering at least one of the following conditions:
UE battery level
QoS or priority of the packet to be transmitted
Load constraints, e.g. network load (e.g. congestion), resource pool(s) usage, channel load (e.g. CBR),

Wherein a UE can adopt at least one of the following strategies to reduce power consumption:
Random selection of radio resources from either X % of (pre-) configured resource pool or a configured or defined resource pool for e.g. random selection only or for P-UEs only; (Embodiment 1)
Radio resource selection based on partial sensing initiated only after traffic arrival. Wherein partial sensing is performed only after traffic arrival to select the appropriate radio resources for the intended (re)-transmission; (Embodiment 2)
A UE can calculate the potential candidate radio resource considering prediction functionality. Wherein prediction functionality is based on the geographical location of nearby users through the user-assisted signaling information provided by the nearby users or exchange signaling between the application layer and physical layer of every user, e.g., CAM; (Embodiment 3, 4). This prediction functionality can be for e.g. a Network function in the core network.

The candidate resources identified based on prediction or based on UE sensing could be either combined or used separately for resource selection.
Partial preemption of the reserved radio resources in the frequency domain. It might be considered only when the preemption is configured by the higher layer, e.g. to address the non-efficient radio resource utilization problem when the preempting UE's subchannel size is smaller than the preempted UE thereof as per previous preemption procedure. (Embodiment 5)

The parameters and random selection procedure described above could be configured by the higher layer signaling through RRC or DCI configuration.

According to embodiments, K for periodic partial sensing can be configured to the most sensing occasions, where the first slot of set of candidate slots is considered as reference point. The partially sensing may have the task to identify/select candidate resources.

For example, if a UE is configured to perform partial sensing, it may continuously perform sensing immediate after triggering resource selection and continues till the first slots of set of candidate slots considering processing time. Alternatively, a UE can start sensing with delay offset immediate after the resource selection is triggered. This offset may be (pre-) configured by the higher layer. In addition, it can be configured as per QoS requirements differently.

According to embodiments, if a UE is configured to perform contiguous partial sensing, immediate after triggering resource selection, time between resource triggering instance and first candidate slot is configured such that to be able to receive the feedback, when HARQ is configured in the resource pool. Expressed in other words, this means that the time between resource triggering instance and first candidate slot is determined sufficient long for receiving feedback or HARQ feedback.

According to embodiments, the transceiver may be configured to perform said sidelink communication, e.g., at time instance m, using selected candidate resources selected out of a set of candidate resources randomly chosen, e.g. from a defined portion of (pre-) configured resource pool or a separate specific resource pool, e.g. configured for random resource selection only, or a (pre-)configured part of a resource pool or to use random resource selection or from any type.

According to embodiments, the selected and/or adapted resource selection strategy is out of the group comprising:
Random selection of candidates resources without (partial) sensing;
Partial sensing based resource selection, where partial sensing is performed only after resource selection was triggered;
Radio resource selection considering prediction functionality, where radio resource selection is based on calculation of the potential candidate resources; and
Radio resource selection based on preemption, limiting resource preemption to the portion of required resources.

According to embodiments, the transceiver may be instructed, e.g. by higher layer signaling or RRC signaling, to select candidate resources randomly from a defined portion of (pre-) configured resource pool or a separate specific resource pool, e.g. for random resource selection only, or a (pre-)configured part of a resource pool or to use random resource selection from any type of resource pool.

According to embodiments, in case of using of random selection of candidate resources the adaption of the radio resource selection strategy comprises an adaption performed with respect to
a defined portion of (pre-) configured resource pool or a separate specific resource pool or a (pre-) configured part of a resource pool;
a specific resource pool RP, e.g., for P-UE(s) or random resource selection or a specific resource pool configured based on a geographical area, e.g., zone, validity area, junction, hot spot area;
a portion of resource pools configured for HARQ or non-HARQ, e.g. allowed to offer x % of its resource pool or the complete resource pool, to be used for random resource selection;
a portion of a resource pool exceeding a defined CBR and/or priority, e.g. exceeding a CBR a portion a threshold and/or allowed to offer x % of its resource pool or the complete resource pool, and to be used for random resource selection;
exceptional pool and/or any other type of resource pool, e.g. additionally configured based on a geographical area, e.g., zone, validity area, junction, hot spot area;
a specific priority of a part of common/normal/shared RP; and/or
remaining PRBs of a resource pool, the remaining PRBs to be used by the UE with limited battery capacity, e.g. in case the configured PRBs for resource pool is not an integer multiple of subchannel size and the size of subchannels in the RP is configured equally; or

wherein a subchannel size is configured as the adaption of the radio resource selection strategy, e.g. by an integer number; exemplary ranging between 1 to 100 when a bandwidth part is 20 MHz, or any other number when a bigger bandwidth is configured.

According to embodiments, partial sensing is performed after triggering of the resource selection or after traffic arrival; or wherein partial sensing is performed only after traffic arrival to select the candidate resources (embodiment 2).

According to embodiments, in case of using of radio resource selection based on partial sensing the adaption of radio resource selection strategy comprises an adaption with regard to
partial sensing parameters;
traffic arrivals/flags for triggering the partial sensing;
sensing time instances K;
sensing duration ts;
pr, _pt, where pr is the priority value that is received in in the control information, e.g., 1^{st} SCI or 2st SCI, and pt is the priority of transmission that depends on the application requirements;
packet delay budget;
number of subchannels;
number of subframes with resource reservations for (re-) transmission; and/or
resource pool, e.g., resource pool identity.

According to embodiments, the candidate resources are calculated by considering prediction functionality; or wherein the candidate resources are calculated by considering prediction functionality and wherein the functionality prediction is based on a geographical location of nearby transceivers, e.g. through the user-assisted signaling information provided by the nearby users or exchange signaling between the application layer and physical layer of every user, e.g., CAM.

According to embodiments, candidate resources are identified based on prediction using the prediction functionality or based on sensing or a combination of prediction functionality and sensing, e.g. combined or used separately for resource selection; alternatively, candidate resources are composed of two independent sets wherein a first set is achieved from normal sensing or partial sensing and a second set is a set of candidate radio resources predictively (randomly and/or geographically) chosen.

According to embodiments, in case the set of remaining candidate radio resources is less than a predetermined value, a priority value or another selection threshold value, e.g. for QoS change, UE speed, supported service or geolocation information, used for the selection of candidate resources is adapted as adaption of a radio resource selection strategy.

According to embodiments, the transceiver may be configured to predict resources of the nearby users approaching an area.

According to embodiments, the transceiver may be configured to predict resources of the nearby users approaching an area based on control information broadcasted transmitted by the nearby users; alternatively, wherein the transceiver is configured to predict resources of the nearby users approaching an area based on control information broadcasted transmitted by the nearby users, wherein the control information indicating at least one out of:
Velocity;
Direction, e.g. b″ bits for orientation information, for example “b” can be 9 bits and be selected form a set of [0-360] degree;
coordinates, e.g. x, y bits for the coordinate of a user that is derived from zone-id or the location information available from for e.g. GNSS RTK broadcast data when it is configured or enabled by the higher layer signaling;
Velocity class, e.g. “v” bits for speed of users, for example, “v” can be 8 bits indicating different velocities and be selected from a set of, [0-250] Kmph, or mph; or
minimum safe relative distance between the UE, e.g. in meters. Except out of the complete Definition as per 5GAA_S-200099_VRU_Safety_Basic Service.pptx: Lateral Distance (LaD), Longitudinal Distance (LoD), Vertical Distance (VD) are measured between nodes. Minimum Safe Lateral Distance (MSLaD), Minimum Safe Longitudinal Distance (MSLoD), Minimum Safe Vertical Distance (MSVD) for VRU profile types, environment conditions, etc. are specified.lf (LaD<MSLaD) & (LoD<MSLoD) & (VD<MSVD) is satisfied collision avoidance actions are.

According to embodiments, the transceiver may be configured to use a partial preemption of reserved candidate resources in the frequency domain and/or time domain; or wherein the transceiver is configured to use a partial preemption of reserved candidate resources in the frequency domain and/or time domain when the preemption configured by the higher layer, e.g. to address the non-efficient radio resource utilization problem, or when the preempting UE's subchannel size is smaller than the preempted UE thereof as per previous preemption procedure or wherein the transceiver of a preempted user is configured to use the remaining radio resource over time/frequency after a partial preemption or wherein the transceiver of a preempted user is configured by the higher layer signaling to use the remaining part of the preempted radio resource over time/frequency domain.

According to embodiments, preemption priority level for the transceiver is adapted as adaption of radio resource selection, e.g. UE with low battery level uses higher preemption priority level]; alternatively, a transceiver having higher preemption priority level may be allowed to use PRBs of a transceiver having lower preemption priority level.

According to embodiments, allowed/enabled/configured or possible preemption is indicated by a control information.

According to embodiments, the transceiver may be configured to receive a control information, e.g., transmitted on a physical layer (e.g. DCI or SCI) or on a higher layer (e.g. RRC)].

According to embodiments, the sidelink communication is a new radio, NR, sidelink communication.

According to embodiments, the transceiver may be configured to operate in a new radio, NR, sidelink mode 1 or mode 2.

According to embodiments, the transceiver may be battery operated. Further embodiment provide a vulnerable road user equipment, VRU-UE, comprising an above transceiver.

A further embodiment provides a method for communicate in a sidelink communication, e.g. NR V2X Mode2, using a transceiver, e.g., VRU-UE, P-UE, V-UE, of a wireless communication network, the method comprising the steps:

selecting, for said sidelink communication, candidate resources, e.g. a set of candidate resources or candidate resource elements, out of resources of the sidelink communication, e.g., sub-channels, a resource pool or a bandwidth part, by use of a radio resource selection strategy, e.g. random selection without sensing; partial sensing based resource selection, where partial sensing is performed after resource selection is triggered, predictive resource selection; preemption limited to required resources]; and adapting radio resource selection strategy dependent at least one parameter out of:
battery level and/or battery type of the transceiver;
QoS or priority of the packet to be transmitted;
Load constraints, e.g. network load (e.g. congestion), resource pool(s) usage, channel load (e.g. CBR)];
Bandwidth part.

This method may be computer implemented.

As mentioned above, there are different main embodiments 1-5:

### Embodiment 1: Random Resource Selection Strategy

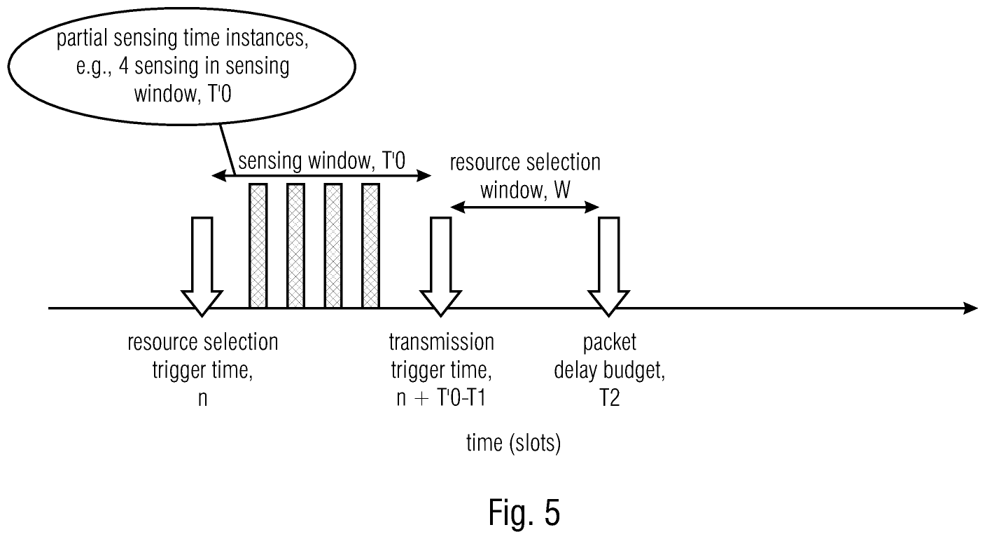

A UE, e.g., with limited battery capacity or level, is instructed e.g. by higher layer signaling to select radio resources randomly from X % of (pre-) configured resource pool or a separate specific resource pool or a (pre-)configured part of a resource pool for e.g. P-UEs or any kind of VRU-UE or for any UE configured/instructed to use random resource selection only. The radio resources are selected from any type of e.g. tx, rx, common or shared Mode 1 and Mode 2 resource pool(s)/exceptional pool (pre-) configured in a carrier or multiple carriers. Wherein the following types of resource pool can be adaptively configured by gNB for a UE:
a specific resource pool (RP) e.g., for P-UE(s) or random resource selection, which could be additionally be configured based on a geographical area, e.g., zone, validity area, junction, hot spot area. For example, FIG. 3 shows a case when an RP consists of L1-L4, and each sub-channel is configured with different sizes. Also, a part of the resource pool is configured to be used for random selection subchannel
only resource pools configured for HARQ or non-HARQ could be allowed to offer x % of its resource pool or the complete resource pool for random resource selection
only resource pool exceeding a defined CBR and/or priority (e.g. exceeding a CBR threshold) could be allowed to offer x % of its resource pool or the complete resource pool for random resource selection
exceptional pool/any other type of resource pool, which could be additionally be configured based on a geographical area, e.g., zone, validity area, junction, hot spot area;
a part of common/normal/shared RP with a specific priority, i.e., X_pri, allocated to a UE;
a resource pool that comprises the remaining PRBs in case the configured PRBs for resource pool is not an integer multiple of subchannel size and the size of subchannels in the RP is configured equally. For example, when a RP consists of the subchannels L1-L6, wherein each subchannel comprises 15 PRBs, respectively (c.f. FIG. 4). The remaining 10 PRBs can be configured for the random selection to be used by the UE with limited battery capacity.

Optionally, independent of the type/setup/configuration of the RP: P-UE SL transmission could be prioritized over the V-UE SL transmission, e.g. in general or depending on the QoS/priority of the P-UE or of the P-UE related to the QoS/priority of the V-UE.

FIG. 3 show a specific resource pool configuration for random selection when subchannels are configured with different size, wherein a part of RP is dedicated to the random selection only. As illustrated the resource pool may be split into x+1 sub-channels with different/flexible sub-channel sizes Lx: Subchannel, x=1, 2, 3, 4.

By use of this strategy a UE with limited battery life, is instructed by the higher layer signaling to select radio resources randomly from X % of (pre-) configured resource pool, wherein the sub-channel can be configured based on:
Geographical area, e.g., zone, validity area
Prioritized sub-channels e.g. for VRUs
Remaining PRBs of a sub-channel, where RP is not integer number of sub-channel

FIG. 4 show a specific resource pool configuration for random resource selection when the subchannel is the same for all 5 subchannels, and a part of resource pool is dedicated to the random selection only.

X % and X_pri are (pre-) configured by the higher layer signaling wherein X % of RP is at least a subchannel that is comprised of N PRB that N is the size of the subchannel. And, X_pri is priority level of the resource pool dedicated to the random selection.

Wherein the subchannel size can be configured by an integer number ranging between 1 to maximum resource block index number for every bandwidth part that is configured by the higher layer. For example, the sub-channel size can be any number from a set of {1, 2, 3, 4, 5, 6, 10, 15, 20, 25, 50, 75, 100} when the bandwidth part is 20 MHz. Also, the UE can be instructed to select multiple subchannel sizes based on the possible reservations (i.e. type of the incoming traffic) that it is going to make. The RP configuration can be configured in the following way for e.g. by RRC configuration:

Example for Modifying the Current SL-ResourcePool Information Element [38.331]

-- ASN1START
-- TAG-SL-RESOURCEPOOL-START

| | |
|---|---|
| SL-ResourcePool-r16 ::= | SEQUENCE { |
| sl-PSCCH-Config-r16 | SetupRelease { SL-PSCCH-Config-r16 } |

OPTIONAL, -- Need M

| | |
|---|---|
| sl-PSSCH-Config-r16 | SetupRelease { SL-PSSCH-Config-r16 } |

OPTIONAL, -- Need M

| | |
|---|---|
| sl-PSFCH-Config-r16 | SetupRelease { SL-PSFCH-Config-r16 } |

OPTIONAL, -- Need M

| | |
|---|---|
| sl-SyncAllowed-r16 | SL-SyncAllowed-r16 |

OPTIONAL, -- Need M

| | |
|---|---|
| sl-mulitple-SubchannelSize-r* | ENUMERATED{ enabled } |
| sL-SubchannelSize-r16 | ENUMERATED {n1, n2, n3, n4, n5, n6, n10, |
| n15, n20, n25, n50, n75, n100} | OPTIONAL, -- Need M |
| sl-Period-r16 | ENUMERATED {ffs} |

OPTIONAL, -- Need M

| | |
|---|---|
| sl-TimeResource-r16 | ENUNERATED {ffs} |

OPTIONAL, Need M

| | |
|---|---|
| sl-StartRB-Subchannel-r16 | INTEGER (0..265) |

OPTIONAL, -- Need M

| | |
|---|---|
| sl-NumSubchannel-r16 | INTEGER (1..27) |

OPTIONAL, -- Need M

| | |
|---|---|
| sl-MCS-Table-r16 | ENUMERATED {qam64, qam256, qam64LowSE} |

OPTIONAL, -- Need M

| | |
|---|---|
| sl-ThreshS-RSSI-CBR-r16 | INTEGER. (0 . . 45) |

OPTIONAL, -- Need M

| | |
|---|---|
| sl-TimeWindowSizeCBR-r16 | ENUMERATED {mms100, slot100} |

OPTIONAL, -- Need M

| | |
|---|---|
| sl-TimeWindowSizeCR-r16 | ENUMERATED {ms1000, slot1000} |

OPTIONAL, -- Need M

| | |
|---|---|
| sl-PTRS-Config-r16 | SL-PTRS-Config-r16 |

OPTIONAL, -- Need M

| | |
|---|---|
| sl-ConfiguredGrantConfigList-r16 | SL-ConfiguredGrantConfigList-r16 |

OPTIONAL, -- Need M

| | |
|---|---|
| sl-UE-SelectedConfigRP-r16 | SL-UE-SelectedConfigRP-r16 |

OPTIONAL, -- Need M

| | |
|---|---|
| sl-RxParametersNcell-r16 | SEQUENCE { |
| sl-TDD-Config-r16 | TDD-UL-DL-ConfigCommon |

OPTIONAL,

| | |
|---|---|
| sl-SyncConfigIndex-r16 | INTEGER (0..15) |

}
OPTIONAL, -- Need M

| | |
|---|---|
| sl-ZoneConfigMCR-List-r16 | SEQUENCE (SIZE (16)) Or SL-ZoneConfigMCR- |
| r16 | OPTIONAL, -- Need M |

...
}

| | |
|---|---|
| SL-ZoneConfigMCR-r16 ::= | SEQUENCE { |
| sl-ZoneConfigMCR-Index-r16 | INTEGER (0..15), |
| sl-TransRange-r16 | ENUMERATED {m20, m50, m80, m100, |

m120, m150, m180, m200, m220, m250, m270, m300, m350,

m370, m400, m420, m450, m480, m500,

m550, m600, m700, m1000, spare8, spare7, spare6,

| | |
|---|---|
| | spare5, spare4, spare3, spare2, |
| spare1} | OPTIONAL, -- Need M |
| sl-ZoneConfig-r16 | SL-ZoneConfig-r16 |

OPTIONAL, -- Need M
...
}

| | |
|---|---|
| SL-SyncAllowed-r16 ::= | SEQUENCE { |
| gnss-Sync-r16 | ENUMERATED {true} OPTIONAL, |

-- Need R

| | |
|---|---|
| gnbEnb-Sync-r16 | ENUMERATED {true} OPTIONAL, |

-- Need P

| | |
|---|---|
| ue-Sync-r16 | ENUMERATED {true} OPTIONAL |

-- Need R
}

| | |
|---|---|
| SL-PSCCH-Config-r16 ::= | SEQUENCE { |
| sl-TimeResourcePSCCH-r16 | ENUMERATED {n2, n3} |

OPTIONAL, -- Need M

| | |
|---|---|
| sl-FreqResourcePSCCH-r16 | ENUMERATED {n10,n12, n15, n20, n25} |

OPTIONAL, -- Need M

| | |
|---|---|
| sl-DMRS-ScreambleID-r16 | INTEGER (0..65535) |

OPTIONAL, -- Need M

| | |
|---|---|
| sl-NumReservedBits-r16 | INTEGER (2..4) |

OPTIONAL, -- Need M
...
}

| | |
|---|---|
| SL-PSSCH-Config-r16 ::= | SEQUENCE { |
| sl-PSSCH-DMRS-TimePattern-r16 | ENUMERATED {ffs} |

OPTIONAL, -- Need M

| | |
|---|---|
| sl-BetaOffsets2ndSCI-r16 | SEQUENCE (SIZE (4)) OF SL-BetaOffsets-r16 |

OPTIONAL, -- Need M

| | |
|---|---|
| sl-Scaling-r16 | ENUMERATED {f0p5, f0p65, f0p8, f1} |

OPTIONAL, -- Need M
...
}

| | |
|---|---|
| SL-PSFCH-Config-r16 ::= | SEQUENCE { |
| sl-PSFCH-Period-r16 | ENUMERATED {s10, s11, s12, s14} |

OPTIONAL, -- Need M

| | |
|---|---|
| sl-PSFCH-RB-Set-r16 | BIT STRING (SIZE (275)) |

OPTIONAL, -- Need M

| | |
|---|---|
| sl-NumMuxCS-Pair-r16 | ENUMERATED {n1, n2, n3, n4, n6} |

OPTIONAL, -- Need M

| | |
|---|---|
| sl-MinTimeGapPSFCH-r16 | ENUMERATED {s12, s13} |

OPTIONAL, -- Need M

| | |
|---|---|
| sl-PSFCH-HopID-r16 | INTEGER (0..1023) |

OPTIONAL, -- Need M
...
}

| | |
|---|---|
| SL-PTRS-Config-r16 ::= | SEQUENCE { |
| sl-PTRS-FreqDensity-r16 | SEQUENCE (SIZE (2) OF INTEGER (1..276) |

OPTIONAL, -- Need M

| | |
|---|---|
| sl-PTRS-TimeDensity-r16 | SEQUENCE (SIZE (3)) OF INTEGER (0..29) |

OPTIONAL, -- Need M

| | |
|---|---|
| sl-PTRS-RE-Offset-r16 | ENUMERATED (offset01, offset10, offset11) |

OPTIONAL, -- Need M
...
}

| | |
|---|---|
| SL-UE-SelectedConfigRP-r16 ::= | SEQUENCE { |
| sl-CBR-Priority-TxConfigList-r16 | SL-CBR-Priority-TxConfigList-r16 |

OPTIONAL, -- Need M

| | |
|---|---|
| sl-ThresPSSCH-RSRP-List-r16 | SL-ThresPSSCH-RSRP-List-r16 |

OPTIONAL, -- Need M

| | |
|---|---|
| sl-MultiReserveResource-r16 | ENUMERATED {enabled} |

OPTIONAL, -- Need M

| | |
|---|---|
| sl-MaxNumPerReserve-r16 | ENUMERATED {n2, n3} |

OPTIONAL, -- Need M

| | |
|---|---|
| sl-SensingWindow-r16 | ENUMERATED {ms100, ms1100} |

OPTIONAL, -- Need M

| | |
|---|---|
| sl-SelectionWindow-r16 | ENUMERATED {n1, n5, n10, n20} |

OPTIONAL, -- Need M

| | |
|---|---|
| sl-ResourceReservePeriodList-r16 | SEQUENCE (SIZE (1..16)) OF SL- |

ResourceReservePeriod-r16 OPTIONAL, -- Need M

| | |
|---|---|
| sl-RS-ForSensing-r16 | ENUMERATED {pscch, pssch}, |
| SL-ResourceReservePeriod-r16 ::= | ENUMERATED {s0, s100, s200, s300, s400, s500, s600, |

s700, s800, s900, s1000}

| | |
|---|---|
| SL-BetaOffsets-r16 ::= | INTEGER (0..31) |
| SL-Premeption-r16::= | ENUMERATED {enabled} |

OPTIONAL, -- Need M
-- TAG-SL-RESOURCEPOOL-STOP
-- ASN1STOP

Another possibility as shown in FIGS. 3 and 4 introduces a new random resource pool for SL. The RRC configuration for example can be as follows:

Example of a SL-RandomResourcePool Information Element [38.331]

-- ASN1START
-- TAG-SL-RANDOMRESOURCEPOOL-START
SL-RandomResourcePool-r16 ::=

| | |
|---|---|
| sl-PSCCH-Config-r16 | SetupRelease { SL-PSCCH-Config-r16 } |

OPTIONAL, -- Need M

| | |
|---|---|
| sl-PSSCH-Config-r16 | SetupRelease { SL-PSSCH-Config-r16 } |

OPTIONAL, -- Need M

| | |
|---|---|
| sl-PSFCH-Config-r16 | SetupRelease { SL-PSFCH-Config-r16 } |

OPTIONAL, -- Need M

| | |
|---|---|
| sl-SyncAllowed-r16 | SL-SyncAllowed-r16 |

OPTIONAL, -- Need M

| | |
|---|---|
| sl-SubchannelSize-r16 | ENUMERATED {n1, n2, n3, n4, n5, n6, n10, |
| n15, n20, n25, n50, n75, n100} | OPTIONAL, -- Need M |
| sl-Period-r16 | ENUMERATED {ffs} |

OPTIONAL, -- Need M

| | |
|---|---|
| sl-TimeResource-r16 | ENUMERATED {ffs} |

OPTIONAL, -- Need M

| | |
|---|---|
| sl-StartRB-Subchannel-r16 | INTEGER (0..265) |

OPTIONAL, -- Need M

| | |
|---|---|
| sl-NumSubchannel-r16 | INTEGER (1..27) |

OPTIONAL, -- Need M

| | |
|---|---|
| sl-MCS-Table-r16 | ENUMERATED {qam64, qam256, qam64LowSE} |

OPTIONAL, -- Need M

| | |
|---|---|
| sl-ThreshS-RSSI-CBR-r16 | INTEGER (0..45) |

OPTIONAL, -- Need M

| | |
|---|---|
| sl-TimeWindowSizeCBR-r16 | ENUMERATED {ms100, slot100} |

OPTIONAL, -- Need M

| | |
|---|---|
| sl-TimeWindowSizeCR-r16 | ENUMERATED {ms1000, slot1000} |

OPTIONAL, -- Need M

| | |
|---|---|
| sl-PTRS-Config-r16 | SL-PTRS-Config-r16 |

OPTIONAL, -- Need M

| | |
|---|---|
| sl-ConfiguredGrantConfigList-r16 | SL-ConfiguredGrantConfigList-r16 |

OPTIONAL, -- Need M

| | |
|---|---|
| sl-UE-SelectedConfigRP-r16 | SL-UE-SelectedConfigRP-r16 |

OPTIONAL, -- Need M

| | |
|---|---|
| sl-RxParametersNcell-r16 | SEQUENCE { |
| sl-TDD-Config-r16 | TDD-UL-DL-ConfigCommon |

OPTIONAL,

| | |
|---|---|
| sl-SyncConfigIndex-r16 | INTEGER (0..15) |

}
OPTIONAL, -- Need M

| | |
|---|---|
| sl-ZoneConfigMCR-List-r16 | SEQUENCE (SIZE (16)) OF SL-ZoneConfigMCR- |
| r16 | OPTIONAL, -- Need M |

...
}

| | |
|---|---|
| SL-ZoneConfigMCR-r16 ::= | SEQUENCE { |
| sl-ZoneConfigMCR-Index-r16 | INTEGER (0..15), |
| sl-TransRange-r16 | ENUMERATED {m20, m50, m80, m100, |

m120, m150, m180, m200, m220, m250, m270, m300, m350,

m370, m400, m420, m450, m480, m500,

m550, m600, m700, m1000, spare8, spare7, spare 6,

| | |
|---|---|
| | spare5, spare4, spare3, spare2, |
| spare1} | OPTIONAL, -- Need M |
| sl-ZoneConfig-r16 | SL-ZoneConfig-r16 |

OPTIONAL, -- Need M
...
}

| | |
|---|---|
| SL-SyncAllowed-r16 ::= | SEQUENCE { |
| gnss-Sync-r16 | ENUMERATED {true} OPTIONAL, |

-- Need R

| | |
|---|---|
| gnbEnb-Sync-r16 | ENUMERATED {true} OPTIONAL, |

-- Need R

| | |
|---|---|
| ue-Sync-r16 | ENUMERATED {true} OPTIONAL |

-- Need R
}

| | |
|---|---|
| SL-PSCCH-Config-r16 ::= | SEQUENCE { |
| sl-TimeResourcePSCCH-r16 | ENUMERATED {n2, n3} |

OPTIONAL, -- Need M

| | |
|---|---|
| sl-FreqResourcePSCCH-r16 | ENUMERATED {n10,n12, n15, n20, n25} |

OPTIONAL, -- Need M

| | |
|---|---|
| sl-DMRS-ScreambleID-r16 | INTEGER (0..65535) |

OPTIONAL, -- Need M

| | |
|---|---|
| sl-NumReservedBits-r16 | INTEGER (2..4) |

OPTIONAL, -- Need M
...
}

| | |
|---|---|
| SL-PSSCH-Config-r16 ::= | SEQUENCE { |
| sl-PSSCH-DMRS-TimePattern-r16 | ENUMERATED {ffs} |

OPTIONAL, -- Need M

| | |
|---|---|
| sl-BetaOffsets2ndSCI-r16 | SEQUENCE (SIZE (4)) OF SL-BetaOffsets-r16 |

OPTIONAL, -- Need M

| | |
|---|---|
| sl-Scaling-r16 | ENUMERATED {f0p5, f0p65, f0p8, f1} |

OPTIONAL, -- Need M
...
}

| | |
|---|---|
| SL-PSFCH-Config-r16 ::= | SEQUENCE { |
| sl-PSFCH-Period-r16 | ENUMERATED {s10, s11, s12, s14} |

OPTIONAL, -- Need M

| | |
|---|---|
| sl-PSFCH-RB-Set-r16 | BIT STRING (SIZE (275)) |

OPTIONAL, -- Need M

| | |
|---|---|
| sl-NumMuxCS-Pair-r16 | ENUMERATED {n1, n2, n3, n4, n6} |

OPTIONAL, -- Need M

| | |
|---|---|
| sl-MinTimeGapPSFCH-r16 | ENUMERATED {s12, s13} |

OPTIONAL, -- Need M

| | |
|---|---|
| sl-PSFCH-HopID-r16 | INTEGER (0..1023) |

OPTIONAL, -- Need M
...
}

| | |
|---|---|
| SL-PTRS-Config-r16 ::= | SEQUENCE { |
| sl-PTRS-FreDensity-r16 | SEQUENCE (SIZE (2)) OF INTEGER (1..276) |

OPTIONAL, -- Need M

| | |
|---|---|
| sl-PTRS-TimeDensity-r16 | SEQUENCE (SIZE (3)) OF INTEGER (0..23) |

OPTIONAL, -- Need M

| | |
|---|---|
| sl-PTRS -RE-Offset-r16 | ENUMERATED {offset01, offset10, offset11} |

OPTIONAL, -- Need M
...
}

| | |
|---|---|
| SL-UE-SelectedConfigRP-r16 ::= | SEQUENCE { |
| sl-CBR-Priority-TxConfigList-r16 | SL-CBR-Priority-TxConfigList-r16 |

OPTIONAL, -- Need M

| | |
|---|---|
| sl-ThresPSSCH-RSRP-List-r16 | SL-ThresPSSCH-RSRP-List-r16 |

OPTIONAL, -- Need M

| | |
|---|---|
| sl-MultiReserveResource-r16 | ENUMERATED {enabled} |

OPTIONAL, -- Need M

| | |
|---|---|
| sl-MaxNumPerReserve-r16 | ENUMERATED {n2, n3} |

OPTIONAL, -- Need M

| | |
|---|---|
| sl-SensingWindow-r16 | ENUMERATED {ms100, ms1100} |

OPTIONAL, -- Need M

| | |
|---|---|
| sl-SelectionWindow-r16 | ENUMERATED {n1, n5, n10, n20} |

OPTIONAL, -- Need M

| | |
|---|---|
| sl-ResourceReservePeriodList-r16 | SEQUENCE (SIZE (1..16) ) OF SL- |

ResourceReservePeriod-r16 OPTIONAL, -- Need M

| | |
|---|---|
| sl-RS-ForSensing-r16 | ENUMERATED {pscch, pssch}, |
| SL-ResourceReservePeriod-r16 ::= | ENUMERATED {s0, s100, s200, s300, s400, s500, s600, |

s700, s800, s900, s1000}

| | |
|---|---|
| SL-BetaOffsets-r16 ::= | INTEGER (0..31) |
| SL-Premeption-r16::= | ENUMERATED {enabled} |

OPTIONAL, -- Need M
-- TAG-SL-RANDOMRESOURCEPOOL-STOP
-- ASN1STOP

### Embodiment 2: Radio Resource Selection Based on Partial Sensing after Triggering of the Resource Selection

A UE is configured to perform partial sensing only after triggering of the resource selection. Wherein, partial sensing parameters, namely partial sensing after traffic arrival flag, sensing time instances “K,” and sensing duration can be configured by the higher layer signaling, e.g., RRC or DCI signaling. An example configuration of RRC is shown below:

Example for a SL-CommTxPoolSensingConfig Information Element [36.331]

-- ASN1START

| | |
|---|---|
| SL-CommTxPoolSensingConfig-r14 ::= | SEQUENCE { |
| pssch-TxConfigList-r14 | SL-PSSCH-TxConfigList-r14, |
| thresPSSCH-RSRP-List-r14 | SL-ThresPSSCH-RSRP-List-r14, |
| threshUEpowerlevel-List-r* | SL-ThreshUEPowerLevel-List-r* |
| restrictResourceReservationPeriod-r14 | SL-RestrictResourceReservationPeriodList-r14 |

OPTIONAL, -- Need OR

| | |
|---|---|
| probResourceKeep-r14 | ENUMERATED {v0, v0dot2, v0dot4, v0dot6, v0dot8, |
| | spare3,spare2, spare1}, |
| p2x-SensingConfig-r14 | SEQUENCE { |
| minNumCandidateSF-r14 | INTEGER (1..13), |
| gapCandidateSensing-r14 | BIT STRING (SIZE (10)) |

} OPTIONAL, -- Need OR

| | |
|---|---|
| sl-ReselectAfter-r14 | ENUMERATED {n1, n2, n3, n4, n5, n6, n7, n8, n9, |
| | spare7, spare6, spare5, spare4, spare3, spare2, |
| | spare1} OPTIONAL -- Need OR |
| p2x_sensingafterreselection | INTEGER (0..1), OPTIONAL - NEED OR |

}
-- ASN1STOP

In resource allocation in mode 2, when partial_sensing_after_traffic is toggled, the higher layer may provide a set of parameters, which could include at least one of the following parameters:
pr, _pt, where pr is the priority value that is received in 1^{st} SCI, and pt is the priority of transmission that depends on the application requirements;
packet delay budget;
number of subchannels;
partial sensing time instances, K;
partial sensing duration, ts;
number of subframes with resource reservations for (re-) transmission;
resource pool, e.g., resource pool identity.

After receiving the information from the higher layer, an example of the possible next steps could be:
1. Radio resources in a subframe R may consist of a set of continuous subchannels in a (pre-) configured RP within time interval [n+T1, n+T2] where n is resource selection triggering time instance, T1 and T2 are the UE processing time and the packet delay budget.
2. The sensing window is defined by the range of [n, T2−T1]. The UE should only perform sensing on time instances indicated by K, where K is a set of sensing-time instances configured by the higher layer. The UE shall continue energy-sensing before every transmission if the number of required resources for transmission “N” is bigger than one, the UE can perform sensing in one of the following sensing intervals configured by the higher layer:
   a. If N>=2, the sensing interval is between [n, n1−T3], where T3>=t_sen and T3=processing time of first transmission+processing time of second transmission.
   b. If N=2, the UE continues the sensing within [n, n1−T3] and [n1, n2−T3] and n1, n2 are first and second transmission time instances that can be configured by the higher layer or can depend on the UE implementation.
   c. If N=3, the UE continues the sensing within [n, n1−T3] and [n1, n2−T3], [n2−n3−T3] and n1, n2, n3 are first, second and third transmission time instances that can be configured by the higher layer or can be depend on the UE implementation.
3. Thereshold Th_p is set by the Th_pr_pt.
4. Sa is set to a union of all radio resources in a slot configured by the higher layer.
5. UE excludes any radio resource slot R from the set Sa if the following conditions are met:
   a. If a time slot m has not been monitored during the sensing time instances, or
   b. for radio resource slot indicated in an SCI format 0-1 with the “resource reservation period” field set to the periodicity value, or
   c. if the UE receives the SCI format 0-1 wherein the “resource reservation period” is set and conditions ‘c’ in 7 are met.
6. UE excludes the radio resources in a slot when backward_indication value is set in the received SCI format 0-1 or configured by sl_backward_offset in an RRC message, wherein the backward_indication value is within [0, window selection size], e.g., window selection size=32 slots, and if
   a. beta_offset value is one bit:
      i. For N=2, n′1=n0, n′2=n1;
      ii. For N=3, n′1=n_−1, n′2=n0, n′3=n, where n_−1, n0, n1 are logical slots with respect to slot that SCI 0-1 format received, and n′1, n′2, n′3 are actual logical slots in Rsvp′, i.e., resource reservation period, indicated by SCI 0-1 format.
   b. beta_offset is two bits:
      i. n′1=n_−2, n′2=n_−1, n′3=n0;
      ii. respect to slot that SCI 0-1 format received, where n_−2, n_−1, n0 are logical slot with respect to slot that SCI 0-1 format received, and n′1, n′2, n′3 are actual logical slots in Rsvp′, i.e., resource reservation period, indicated by SCI 0-1 format.
7. The UE could exclude the selected candidate resource R during the sensing procedure if the following conditions are met:
   a. The UE receives an SCI format 0-1 in slot n that indicates the “resource reservation period,” and the priority is higher than priority of transmission configured by the higher layer;
   b. The RSRP measurement for the received SCI format 0-1 is higher than the priority of the intended transmission;
   c. If the indicated radio resource in slots n_(y+i*R′svp_rx) in SCI format 0-1 is present and overlaps with the reserved resource for the intended transmission, i.e., Ry+j*R′svp_tx, for i=0, 1, 2, 3, . . . , l and j=0, 1, 2, C_resl−1. Where R′ is logical slots and l=ceil (Tscal/Rsvp_rx) if Rsvp_rx<Tscal, and n′<=y+R′svp_rx. Where n′1=n1 if n belongs to the set of intended transmission time instances; otherwise, it is the first slot after n1 belonging to the same set. Otherwise 1=1. Note that, Tscal for the normal sensing and the partial sensing before traffic arrival yields:

Tscal=T2−T1−n,
and in the case of partial sensing only after traffic arrival, the Tscal is computed as follows:

Tscal=T2−T1−n−|K|*Tsen.
Where T1 and T2 are the processing time and packet delay budget, wherein T1 depends on the subcarrier spacing or the UE implementation. The traffic arrival, the number of partial sensing time instances, and the sensing duration are shown with n, K, and Tsen, respectively.
Note: the selected resources in the first sensing interval for all transmissions can be altered if the identified radio resources in the second or third sensing interval differ with the one in the first sensing interval when the options b and c in step 2 are taken into consideration.
8. After radio resource exclusion, if the number of remaining radio resource slots in Sa is less than x*Mtotal, Th(pi) is increased by “y” dB, and the procedure continues with step 4. Wherein x and y are the percentage of the minimum number of the total resource pool, Mtotal, and received signal strength threshold that can be configured differently through the higher layer signaling, i.e. RRC. For example, x can be set to one of the values in the set {5, 10, 20, 30, 50} when the power level of the user is lower than a threshold configured by the higher layer signaling. Another example, y can be set to one of the values in the set {1, 2, 3} as per QoS requirement and the level of UE's battery configured by the higher layer signaling.

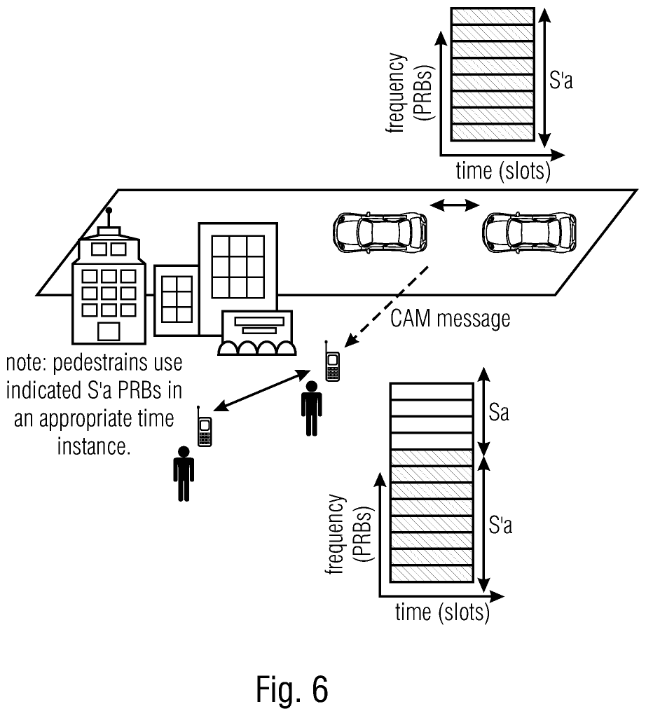

FIG. 5 shows a scenario where the traffic arrives at the time instance “n” and partial sensing only after traffic arrival is instructed. This way, the UE is mandated to perform sensing after “n” and before e.g. “m=n+T′0−T1,” where “m” is up to the UE implementation and might be smaller than the packet delay budget, i.e., T2, and window selection duration.

FIG. 5 shows partial sensing performed after triggering resource selection procedure. According to this approach the a UE may be configured to perform partial sensing only after the traffic arrival aiming to reduce power consumption For example, four sensing time instances are mandated after radio resource selection is triggered.

### Embodiment 3: Radio Resource Selection Considering Predicted Candidate Radio Resource

A candidate radio resource set is composed of two independent sets of Sa and S′a wherein Sa is achieved from normal sensing/partial sensing and S′a is a set of candidate radio resources that might be computed as follows:
If a UE a specific resource pool e.g. for P-UE(s) or random resource selection, which could be additionally be configured based on a geographical area, e.g., zone, validity area, junction, hot spot area. For example, FIG. 3 shows a case when a RP consists of L1-L4 and each sub-channel is configured with different size. Also, a part of resource pool is configured to be used for the random selection.
For example, the UE identifies that the nearby users are approaching a tunnel

Wherein the UE may identify the geographical location of other users based on:
the relative/absolute velocity computed based on received V2X message e.g. cooperative awareness message (CAM) or Vulnerable User awareness message (VAM) (in the application layer to be used at PHY)), or
geo-location-based on a digital map (e.g. GNSS) or geographical information system (GIS).
as per the minimum safe relative distance, e.g., 2 s, or 5 s rules for safe distance or brake

Wherein a UE could e.g. calculate the potential candidate radio resource based on prediction functionality when it is configured by the higher layer signaling, e.g., RRC message, or if the UE is predication capable, i.e., UE implementation.

Example of a SL-CommTxPoolSensingConfig Information Element [36.331]

-- ASN1START

| | |
|---|---|
| SL-CommTxPoolSensingConfig-r14 ::= | SEQUENCE { |
| pssch-TxConfigList-r14 | SL-PSSCH-TxConfigList-r14, |
| thresPSSCH-RSRP-List-r14 | SL-ThresPSSCH-RSRP-List-r14, |
| threshUEpowerlevel-List-r* | SL-ThreshUEPowerLevel-List-r* |
| restrictResourceReservationPeriod-r14 | SL-RestrictResourceReservationPeriodList-r14 |

OPTIONAL, -- Need OR

| | |
|---|---|
| probResourceKeep-r14 | ENUMERATED {v0, v0dot2, v0dot4, v0dot6, v0dot8, |
| | spare3,spare2, spare1}, |
| PredictedResourceList-r* | SEQUENCE (SIZE (1..maxSL-TxPool-r*)) OF SL TxPoolIdentity- |

r*

| | |
|---|---|
| p2x-SensingConfig-r14 | SEQUENCE { |
| minNumCandidateSF-r14 | INTEGER (1..13), |
| gapCandidateSensing-r14 | BIT STRING (SIZE (10)) |

} OPTIONAL, -- Need OR

| | |
|---|---|
| sl-ReselectAfter-r14 | ENUMERATED {n1, n2, n3, n4, n5, n6, n7, n8, n9, |
| | spare7, spare6, spare5, spare4, spare3, spare2, |
| | spare1} OPTIONAL -- Need OR |
| p2x_sensingafterreselection | INTEGER (0..1), OPTIONAL - NEED OR |

}
-- ASN1STOP

In correspondence to the above definition, step 4 and 7 in the resource selection procedure [2, subclause 8.1.4] could be rewritten as follows:
4) The set Sa is initialized to the set of all candidate radio time resource, and the S′a is a set of the predicted radio time resource configured by the higher layer signaling;
7) If the set of remaining candidate radio resources in (Sa+S′a) is less than 0.2*Mtotal, then Th(pi) is increased by 3 dB for each priority value Th(pi), and the procedure is started from step 4).

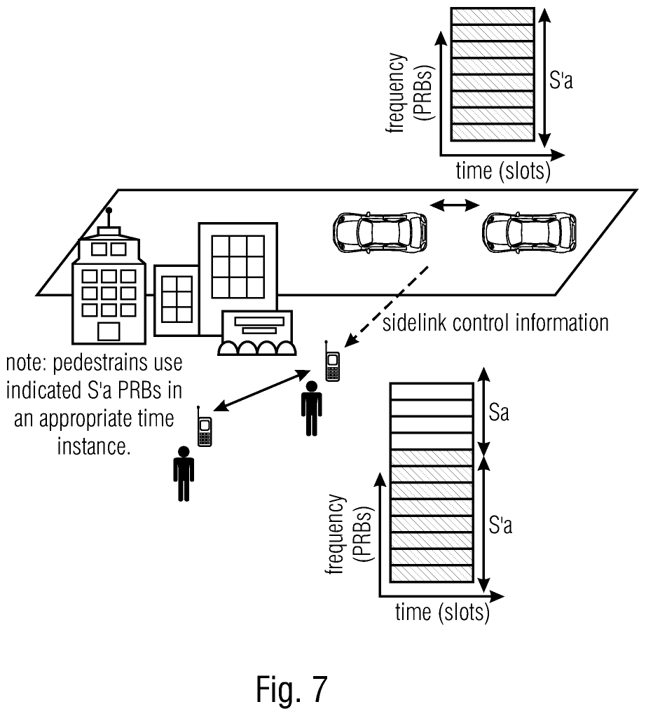

The UE may report the Sa+S′a to the higher layer. FIG. 6 shows the resource selection procedure based on application messages, i.e., cooperative awareness message. Here, the predictive candidate resources may be based on application layer signaling/physical layer signaling. For example, a candidate radio resource set is composed of two independent sets of Sa and S′a wherein Sa is achieved from the full/partial sensing and S′a is a set of predicted candidate radio resources.

For enabling the predictive resource selection behavior which is likely to be UE specific the network functions should have a capability to deliver this information to the UE. For example, access and mobility management function (AMF) in the network supports radio resource management in RAN, should provide an “index of predictive resources (PR)” to the RAN across N2 interface. This could be frequency specific or RAT specific and could be triggered because of QoS changes [7].

Another possibility could be that a new network function is defined which a central entity for providing predictive resources to UEs is based on triggering conditions for e.g. QoS change, UE speed, supported service or geolocation information.

### Embodiment 4: Radio Resource Selection Considering User-Assisted Information

The UE could predict the radio resources of the nearby users approaching an area, wherein line-of-sight and non-line-of sight are delimited by obstacle only if:
the nearby UEs broadcast some control information indicating at least one out of velocity, direction, or coordinates that can assist other UEs with the prediction-based resource selection procedure. Wherein the 2^{nd} stage or 1^{st} stage of SCI could comprise at least one of the following parameters:
   “v” bits for speed of users, for example, “v” can be 8 bits indicating different velocities and be selected from a set of [0-250] Kmph, or mph;
   “b” bits for orientation information, for example “b” can be 9 bits and be selected form a set of [0-360] degree
   x, y bits for the coordinate of a user that is derived from zone-id or the location information available from for e.g. GNSS RTK broadcast data when it is configured or enabled by the higher layer signaling.
   minimum safe relative distance between the UEs in meters, wherein a control/data information can be reliably decoded. This could include both the longitudinal and latitude distance between the UEs. Also, it could be different for different VRU types or P-UEs. This could be provided by the RRC signaling or via DCI as UE assistance information based on for e.g. VRU types.
One possible example could be to define a SL IE for considering the user assisted information which could be either independently defined or appended to the UE assistance information
Example of a SL-IE User Assisted Information for radio resource prediction

-- ASN1START
SL-SensorConfig-r* ::= SEQUENCE {
Speed-r* ENUMERATED { ms0, ms20, ms30, ms50, ms70, ms100, ms200, ms250, spare1, spare2}, %m here
corresponds to meter per second

| | |
|---|---|
| Orientation-r* | ENUMERATED { d0, d10, d20, d50, d100, d200, d250, d360, spare1}, |
| Location-r* | ENUMERATED {enabled} |

Minimum_safe_relative_distance ENUMERATED { m0, m2, m3, m5, m7, m10, m20, m25, spare1, spare2}

| | |
|---|---|
| -- | ASN1STOP |

Wherein a UE can calculate a set of candidate radio resources based on the calculation when it is configured by the higher layer signaling as shown in the example below. Example of a SL-CommTxPoolSensingConfig information element [36.331]

-- ASN1START

| | |
|---|---|
| SL-CommTxPoolSensingConfig-r14 ::= | SEQUENCE { |
| pssch-TxConfigList-r14 | SL-PSSCH-TxConfigList-r14, |
| thresPSSCH-RSRP-List-r14 | SL-ThresPSSCH-RSRP-List-r14, |
| threshUEpowerlevel-List-r* | SL-ThreshUEPowerLevel-List-r* |
| restrictResourceReservationPeriod-r14 | SL-RestrictResourceReservationPeriodList-r14 |

OPTIONAL, -- Need OR

| | |
|---|---|
| probResourceKeep-r14 | ENUMERATED {v0, v0dot2, v0dot4, v0dot6, v0dot8, |
| | spare3,spare2, spare1}, |
| PredictedResourceList-r* | SEQUENCE (SIZE (1..maxSL-TxPool-r*)) OF SL TxPoolIdentity- |

r*

| | |
|---|---|
| p2x-SensingConfig-r14 | SEQUENCE { |
| minNumCandidateSF-r14 | INTEGER (1..13), |
| gapCandidateSensing-r14 | BIT STRING (SIZE (10)) |
| } OPTIONAL, -- Need OR | |
| sl-ReselectAfter-r14 | ENUMERATED {n1, n2, n3, n4, n5, n6, n7, n8, n9, |
| | spare7, spare6, spare5, spare4, spare3, spare2, |
| | spare1} OPTIONAL -- Need OR |
| p2x_sensingafterreselection | INTEGER (0..1), OPTIONAL - NEED OR |

}
-- ASN1STOP

In correspondence to the above definition, the following steps in the resource selection procedure [2, subclause 8.1.4] may be added or rewritten as stated in the following example:
3.1) the UE decodes the information indicated in the sidelink control information, for example, velocity, zone id, and bearing information, and transmits them to the higher layers when it is configured by the higher layer signaling information, e.g., RRC message;
4) the set Sa is initialized to the set of all candidate radio time resources, and the S′a is a set of the predicted radio time resource configured by the higher layer signaling;
7) If the set of remaining candidate radio resource in (Sa+S′a) is less than 0.2*Mtotal, then Th(pi) is increased by 3 dB for each priority value Th(pi), and the procedure is started from step (4).

The UE may report the Sa+S′a to the higher layer. FIG. 7 illustrates predictive resource selection based on the explicit sidelink control information as explained above.

FIG. 7 shows predictive resource selection based on explicit sidelink control information. Note, in Mode 2, a UE is instructed to preempt the reserved radio resource from other users indicated in received SCI format 0-1, when it is configured by higher layer parameters, e.g., RRC, for preemption per resource pool.

### Embodiment 5: Partial Preemption of Radio Resources for Radio Resource Selection

In resource selection mode 2, a UE is instructed to preempt a part of the reserved radio time resources by other users as indicated in received SCI format 0-1, when it is configured by higher layer parameters, e.g., RRC, for partial preemption per resource pool.

Example of how to Adapt the Current SL-ResourcePool Information Element [38.331]

-- ASN1START
-- TAG-SL-RESOURCEPOOL-START

| | |
|---|---|
| SL-ResourcePool-r16 ::= | SEQUENCE { |
| sl-PSCCH-Config-r16 | SetupRelease { SL-PSCCH-Config-r16 } |

OPTIONAL, -- Need M

| | |
|---|---|
| sl-PSSCH-Config-r16 | SetupRelease { SL-PSSCH-Config-r16 } |

OPTIONAL, -- Need M

| | |
|---|---|
| sl-PSFCH-Config-r16 | SetupRelease { SL-PSFCH-Config-r16 } |

OPTIONAL, -- Need M

| | |
|---|---|
| sl-SyncAllowed-r16 | SL-SyncAllowed-r16 |

OPTIONAL, -- Need M

| | |
|---|---|
| sl-mulitple-SubchannelSize-r* | ENUMERATED { enabled } |
| sl-SubchannelSize-r16 | ENUMERATED {n1, n2, n3, n4, n5, n6, n10, |
| n15, n20, n25, n50, n75, n100} | OPTIONAL, -- Need M |
| sl-Period-r16 | ENUMERATED {ffs} |

OPTIONAL, -- Need M

| | |
|---|---|
| sl-TimeResource-r16 | ENUMERATED {ffs} |

OPTIONAL, -- Need M

| | |
|---|---|
| sl-StartRB-Subchannel-r16 | INTEGER (0..265) |

OPTIONAL, -- Need M

| | |
|---|---|
| sl-NumSubchannel-r16 | INTEGER (1..27) |

OPTIONAL, -- Need M

| | |
|---|---|
| sl-MCS-Table-r16 | ENUMERATED {qam64, qam256, qam64LowSE} |

OPTIONAL, -- Need M

| | |
|---|---|
| sl-ThreshS-RSSI-CBR-r16 | INTEGER (0..45) |

OPTIONAL, -- Need M

| | |
|---|---|
| sl-TimeWindowSizeCBR-r16 | ENUMERATED {ms100, slot100} |

OPTIONAL, -- Need M

| | |
|---|---|
| sl-TimeWindowSizeCR-r16 | ENUMERATED {ms1000, slot1000} |

OPTIONAL, -- Need M

| | |
|---|---|
| sl-PTRS-Config-r16 | SL-PTRS-Config-r16 |

OPTIONAL, -- Need M

| | |
|---|---|
| sl-ConfiguredGrantConfigList-r16 | SL-ConfiguredGrantConfigList-r16 |

OPTIONAL, -- Need M

| | |
|---|---|
| sl-UE-SelectedConfigRP-r16 | SL-UE-SelectedConfigRP-r16 |

OPTIONAL, -- Need M

| | |
|---|---|
| sl-RxParametersNcell-r16 | SEQUENCE { |
| sl-TDD-Config-r16 | TDD-UL-DL-ConfigCommon |

OPTIONAL,

| | |
|---|---|
| sl-SyncConfigIndex-r16 | INTEGER (0..15) |

}
OPTIONAL, -- Need M

| | |
|---|---|
| sl-ZoneConfigMCR-List-r16 | SEQUENCE (SIZE (16)) OF SL-ZoneConfigMCR- |
| r16 | OPTIONAL, -- Need M |

...
}

| | |
|---|---|
| SL-ZoneConfigMCR-r16 ::= | SEQUENCE { |
| sl-ZoneConfigMCR-Index-r16 | INTEGER (0..15), |
| sl-TransRange-r16 | ENUMERATED {m20, m50, m80, m100, |

m120, m150, m180, m200, m220, m250, m270, m300, m350,

m370, m400, m420, m450, m480, m500,

m550, m600, m700, m1000, spare8, spare7, spare 6,

| | |
|---|---|
| | spare5, spare4, spare3, spare2, |
| spare1} | OPTIONAL, -- Need M |
| sl-ZoneConfig-r16 | SL-ZoneConfig-r16 |

OPTIONAL, -- Need M
...
}

| | |
|---|---|
| SL-SyncAllowed-r16 ::= | SEQUENCE { |
| gnss-Sync-r16 | ENUMERATED {true} 0PTIONAL, |

-- Need R

| | |
|---|---|
| gnbEnb-Sync-r16 | ENUMERATED {true} OPTIONAL, |

-- Need R

| | |
|---|---|
| ue-Sync-r16 | ENUMERATED {true} OPTIONAL |

-- Need P
}

| | |
|---|---|
| SL-PSCCH-Config-r16 ::= | SEQUENCE { |
| sl-TimeResourcePSCCH-r16 | ENUMERATED {n2, n3} |

OPTIONAL, -- Need M

| | |
|---|---|
| sl-FreqResourcePSCCH-r16 | ENUMERATED {n10,n12, n15, n20, n25} |

OPTIONAL, -- Need M

| | |
|---|---|
| sl-DMRS-ScreambleID-r16 | INTEGER (0..65535) |

OPTIONAL, -- Need M

| | |
|---|---|
| sl-NumReservedBits-r16 | INTEGER (2..4) |

OPTIONAL, -- Need M
...
}

| | |
|---|---|
| SL-PSSCH-Config-r16 ::= | SEQUENCE { |
| sl-PSSCH-DMRS-TimePattern-r16 | ENUMERATED {ffs} |

OPTIONAL, -- Need M

| | |
|---|---|
| sl-BetaOffsets2ndSCI-r16 | SEQUENCE (SIZE (4)) OF SL-BetaOffsets-r16 |

OPTIONAL, -- Need M

| | |
|---|---|
| sl-Scaling-r16 | ENUMERATED {f0p5, f0p65, f0p8, f1} |

OPTIONAL, -- Need M
...
}

| | |
|---|---|
| SL-PSFCH-Config-r16 ::= | SEQUENCE { |
| sl-PSFCH-Period-r16 | ENUMERATED {s10, s11, s12, s14} |

OPTIONAL, -- Need M

| | |
|---|---|
| sl-PSFCH-RB-Set-r16 | BIT STRING- (SITE (275)) |

OPTIONAL, -- Need M

| | |
|---|---|
| sl-NumMuxCS-Pair-r16 | ENUMERATED {n1, n2, n3, n4, n6} |

OPTIONAL, -- Need M

| | |
|---|---|
| sl-MinTimeGapPSFCH-r16 | ENUMERATED {s12, s13} |

OPTIONAL, -- Need M

| | |
|---|---|
| sl-PSFCH-HopID-r16 | INTEGER (0..1023) |

OPTIONAL, -- Need M
...
}

| | |
|---|---|
| SL-PTRS-Config-r16 ::= | SEQUENCE { |
| sl-PTRS-FreqDensity-r16 | SEQUENCE (SIZE (2)) OF INTEGER (1..276) |

OPTIONAL, -- Need M

| | |
|---|---|
| sl-PTRS-TimeDensity-r16 | SEQUENCE (SIZE (3)) OF INTEGER (0..29) |

OPTIONAL, -- Need M

| | |
|---|---|
| sl-PTRS-RE-Offset-r16 | ENUMERATED (offset01, offset10, offset11) |

OPTIONAL, -- Need M
...
}

| | |
|---|---|
| SL-UE-SelectedConfigRP-r16 ::= | SEQUENCE { |
| sl-CBR-Priority-TxConfigList-r16 | SL-CBR-Priority-TxConfigList-r16 |

OPTIONAL, -- Need M

| | |
|---|---|
| sl-ThresPSSCH-RSRP-List-r16 | SL-ThresPSSCH-RSRP-List-r16 |

OPTIONAL, -- Need M

| | |
|---|---|
| sl-MultiReserveResource-r16 | ENUMERATED {enabled} |

OPTIONAL, -- Need M

| | |
|---|---|
| sl-MaxNumPerReserve-r16 | ENUMERATED {n2, n3} |

OPTIONAL, -- Need M

| | |
|---|---|
| sl-SensingWindow-r16 | ENUMERATED {ms100, ms1100} |

OPTIONAL, -- Need M

| | |
|---|---|
| sl-SelectionWindow-r16 | ENUMERATED {n1, n5, n10, n20} |

OPTIONAL, -- Need M

| | |
|---|---|
| sl-ResourceReservePeriodList-r16 | SEQUENCE (SIZE (1..16)) OF SL- |

ResourceReservePeriod-r16 OPTIONAL, -- Need M

| | |
|---|---|
| sl-RS-ForSensing-r16 | ENUMERATED {pscch, pssch}, |
| SL-ResourceReservePeriod-r16 ::= | ENUMERATED {s0, s100, s200, s300, s400, s500, s600, |

s700, s800, s900, s1000}

| | |
|---|---|
| SL-BetaOffsets-r16 ::= | INTEGER (0..31) |
| SL-Premeption-r16::= | ENUMERATED {enabled} |

OPTIONAL, -- Need M

| | |
|---|---|
| SL-PartialPremeption-r*::= | ENUMERATED {enabled} |

OPTIONAL, -- Need M
-- TAG-SL-RESOURCEPOOL-STOP
-- ASN1STOP

Wherein, a preemption priority level, ranging e.g. between {1 . . . 8}, could be configured for every UE. Note that preemption could be triggered:
If the priority configured in SCI associated with a transmitting UE is higher than the priority of the UE, the resources could be preempted as indicated in the received sidelink control information. For example, a UE with low battery level might be configured with a higher priority compared to a UE with a medium or high battery level. Alternatively, also the battery level could be used directly to allow preemption (without mapping to the preemption priority).

In the preemption procedure, also a partial preemption is allowed.

Wherein a UE can preempt a part of radio time/frequency resources reserved by the other UE when preemption applies, and partial preemption is allowed/enabled/configured or possible, which might be indicated by.
one bit in SCI format 0-1, indicating the partial preemption of the initial reserved radio resource.

For example, in correspondence to the above definition, step 5) in the resource selection procedure [2, subclause 8.1.4] might be added/adapted:
The UE may exclude any single radio resource in slot n, and “resource reservation period,” i.e., Rsvp, and when the conditions of c in step 6) in [2, subclause 8.1.4] are met if
   preemption per resource pool is configured by the higher layer, e.g. RRC, and one bit in SCI format 0-1 indicating the partial preemption of reserved radio resources is toggled.

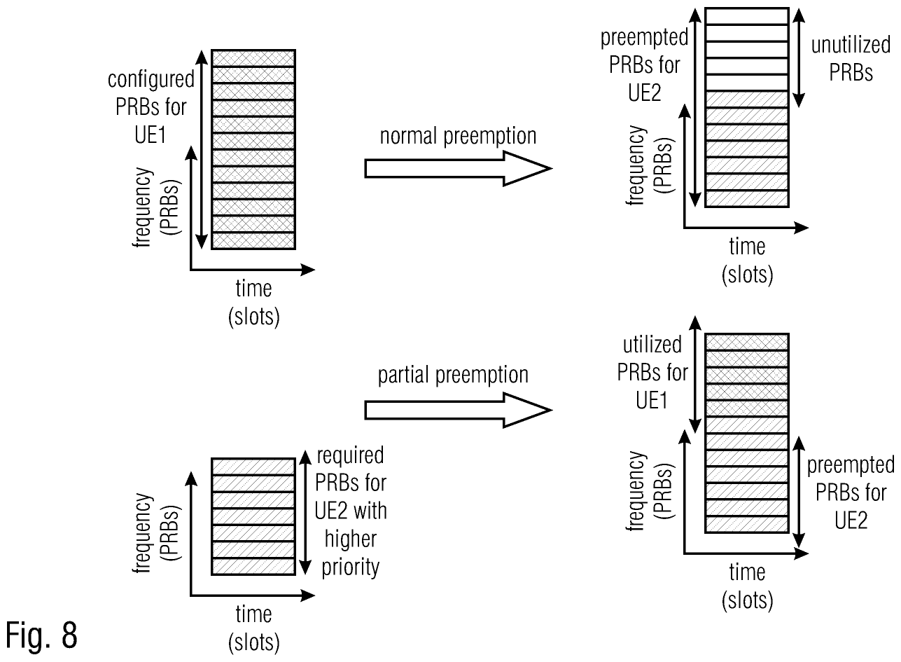

For example, user 1 reserves a sub-channel whose sub-channel comprises 12 PRBs and the priority level is set to 7. User 2 with lower battery is set to the higher priority level 8 and is allowed or instructed to preempt a sub-channel with 7 PRBs. In regular preemption procedure, the user is mandated to release the whole reserved sub-channel/PRBs and initiate a new radio resource (re-) selection procedure. However, when the partial preemption of reserved subchannel/PRBs is allowed, user 2 preempts only 7 PRBs, and user 1 can still transmit the remaining data with a sub-channel comprising 5 PRBs, and initiates a new radio resource (re-)selection procedure with smaller sub-channel size (c.f. FIG. 8). FIG. 8 illustrates partial preemption of already reserved sub-channel, where the upper figure shows preemption allowing only preemption of all UE₁ PRBs (resulting in unused resources (white PRBs on the top), and where the lower figure shows partial preemption of PRBs, resulting on allowing UE₁ to use the unused PRBs of the preempting UE₂.

Aspect described herein may be included in a Rel-17 TS, so it is part of the 5G NR V2X standard. Embodiments described herein can be implemented according to a 5G NR V2X standard. Aspect may be specified in a TS, all UE vendors offering V2X need to use aspect described herein. Embodiments described herein can be implemented according TS.

According to some implantations UE may be VRU UEs exposed to traffic, e.g. pedestrians, cyclists, scooter, and any other type of VRU are the potential customers demanding these power saving procedures for V2X application. Even electronic vehicles and e-bikes may consider energy saving for their equipped UEs.

Further embodiments use sensing and resource allocation are continuously performed procedures by V2X UEs in mode 2 (expected as the common V2X mode for direct communication), consuming continuously and significantly the UE's limited battery power. Especially to ensure safety-critical V2X application, energy saving for VRUs is essential.

In accordance with embodiments, the wireless communication system may include a terrestrial network, or a non-terrestrial network, or networks or segments of networks using as a receiver an airborne vehicle or a spaceborne vehicle, or a combination thereof.

In accordance with embodiments of the present invention, a user device comprises one or more of the following: a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and requiring input from a gateway node at periodic intervals, a mobile terminal, or a stationary terminal, or a cellular IoT-UE, or a vehicular UE, or a vehicular group leader (GL) UE, or a sidelink relay, or an IoT or narrowband IoT, NB-IoT, device, or wearable device, like a smartwatch, or a fitness tracker, or smart glasses, or a ground based vehicle, or an aerial vehicle, or a drone, or a moving base station, or road side unit (RSU), or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

In accordance with embodiments of the present invention, a base station comprises one or more of the following: a macro cell base station, or a small cell base station, or a central unit of a base station, or a distributed unit of a base station, or a road side unit (RSU), or a UE, or a group leader (GL), e.g. a GL-UE, or a relay or a remote radio head, or an AMF, or an MME, or an SMF, or a core network entity, or mobile edge computing (MEC) entity, or a network slice as in the NR or 5G core context, or any transmission/reception point, TRP, enabling an item or a device to communicate using the wireless communication network, the item or device being provided with network connectivity to communicate using the wireless communication network.

Although some aspects of the described concept have been described in the context of an apparatus, it is clear that these aspects also represent a description of the corresponding method, where a block or a device corresponds to a method step or a feature of a method step. Analogously, aspects described in the context of a method step also represent a description of a corresponding block or item or feature of a corresponding apparatus.

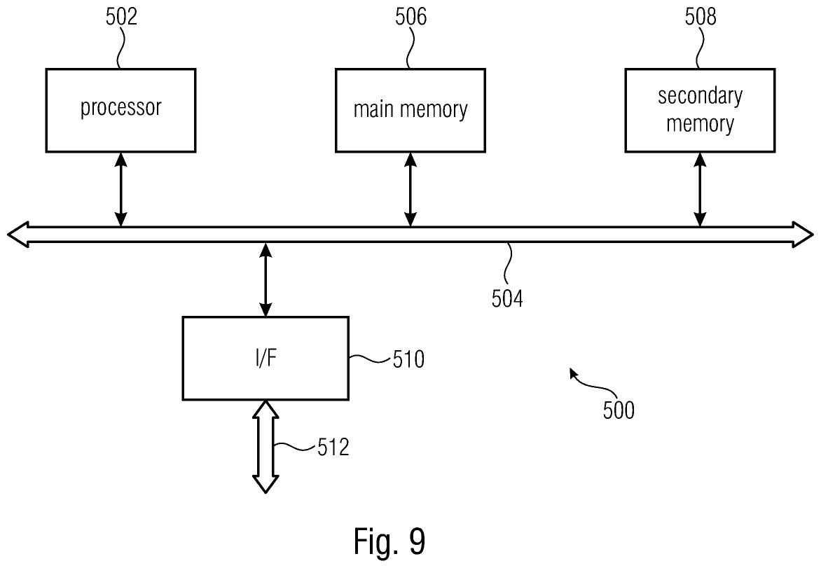

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 9 illustrates an example of a computer system 800. The units or modules as well as the steps of the methods performed by these units may execute on one or more computer systems 800. The computer system 800 includes one or more processors 802, like a special purpose or a general-purpose digital signal processor. The processor 802 is connected to a communication infrastructure 804, like a bus or a network. The computer system 800 includes a main memory 806, e.g., a random-access memory, RAM, and a secondary memory 808, e.g., a hard disk drive and/or a removable storage drive. The secondary memory 808 may allow computer programs or other instructions to be loaded into the computer system 800. The computer system 800 may further include a communications interface 810 to allow software and data to be transferred between computer system 800 and external devices. The communication may be in the from electronic, electromagnetic, optical, or other signals capable of being handled by a communications interface. The communication may use a wire or a cable, fiber optics, a phone line, a cellular phone link, an RF link and other communications channels 812.

The terms “computer program medium” and “computer readable medium” are used to generally refer to tangible storage media such as removable storage units or a hard disk installed in a hard disk drive. These computer program products are means for providing software to the computer system 800. The computer programs, also referred to as computer control logic, are stored in main memory 806 and/or secondary memory 808. Computer programs may also be received via the communications interface 810. The computer program, when executed, enables the computer system 800 to implement the present invention. In particular, the computer program, when executed, enables processor 802 to implement the processes of the present invention, such as any of the methods described herein. Accordingly, such a computer program may represent a controller of the computer system 800. Where the disclosure is implemented using software, the software may be stored in a computer program product and loaded into computer system 800 using a removable storage drive, an interface, like communications interface 810.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate or are capable of cooperating with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier. In other words, an embodiment of the inventive method is, therefore, a computer program having a program code for performing one of the methods described herein, when the computer program runs on a computer.

A further embodiment of the inventive methods is, therefore, a data carrier or a digital storage medium, or a computer-readable medium comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device, for example a field programmable gate array, may be used to perform some or all of the functionalities of the methods described herein. In some embodiments, a field programmable gate array may cooperate with a microprocessor in order to perform one of the methods described herein. Generally, the methods are performed by any hardware apparatus.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

REFERENCES

| Reference | Label Details |
|---|---|
| [1] | 3GPP TS 36.213 V15.8.0 (2019 December) |
| [2] | 3GPP TS 38.214 V16.0.0 (2019 December) |
| [3] | 3GPP TS 36.331 V15 |
| [4] | 3GPP TS 38.331 V16 |
| [5] | 3GPP TR 37.985 V1.1.0 (2020 February) |
| [6] | 3GPP RP-19322, Work Item Description, NR Sidelink |
| | enhancements, Rel-17 |
| [7] | 3GPP 23.501 V16.4.0 |

### Abbreviations

Abbreviation Meaning
VRU Vulnerable road user, typically using battery-based UEs for V2X applications. VRUs include, e.g. pedestrians, cyclists and anybody else involved in traffic scenarios.
DRX Discontinous reception
V-UE Vehicular User Equipment. a vehicular mounted UE
P-UE Pedestrian UE: should not be limited to pedestrians, but represents any UE with a need to save power, e.g. electrical cars, cyclists, other VRUs
WI Work Item
SCS Sub-Carrier Spacing
Pstep Sensing step size
P_rsvp_TX Resource reservation time period for transmission
P_rsvp_RX Resource reservation time period indicated on the received control information
RP Resource pool

1. Transceiver of a wireless communication network, the transceiver being configured to communicate in a sidelink communication;
wherein the transceiver is configured to select, for said sidelink communication, candidate resources out of resources of the sidelink communication by use of a radio resource selection strategy; and
wherein the transceiver is configured to adapt a radio resource selection strategy dependent at least one parameter out of:
battery level and/or battery type of the transceiver;
QoS or priority of the packet to be transmitted;
Load constraints, resource pool; usage, channel load;
Bandwidth part;
resource pool;
characterized in that (i) the transceiver is instructed to select candidate resources randomly from a defined portion of a pre-configured or configured resource pool or a separate specific resource pool or a pre-configured or configured part of a resource pool or to use random resource selection in any type of resource pool; wherein in case of using of radio resource selection based on random resource selection the adaption of a radio resource selection strategy comprises an adaption with regard to at least one parameter out of
partial sensing parameters;
traffic arrivals/flags for triggering the partial sensing;
sensing time instances K;
sensing duration ts;
pr, _pt, where pr is the priority value that is received in in the control information, and pt is the priority of transmission that depends on the application requirements;
packet delay budget;
number of subchannels;
number of subframes with resource reservations for retransmission or transmission; and/or
resource pool.

2. Transceiver of a wireless communication network, the transceiver being configured to communicate in a sidelink communication;
wherein the transceiver is configured to select, for said sidelink communication, candidate resources out of resources of the sidelink communication by use of a radio resource selection strategy; and
wherein the transceiver is configured to adapt a radio resource selection strategy dependent at least one parameter out of:
battery level and/or battery type of the transceiver;
QoS or priority of the packet to be transmitted;
Load constraints, resource pool; usage, channel load;
Bandwidth part;
resource pool;
characterized in that (ii) partial sensing is performed or continuously performed immediate after triggering or after triggering with a delay offset; and/or wherein partial sensing is performed or continuously performed till a first slots of set of candidate slots considering processing time; wherein in case of using of radio resource selection based on partial sensing the adaption of a radio resource selection strategy comprises an adaption with regard to at least one parameter out of
partial sensing parameters;
traffic arrivals/flags for triggering the partial sensing;
sensing time instances K;
sensing duration ts;
pr, _pt, where pr is the priority value that is received in in the control information, and pt is the priority of transmission that depends on the application requirements;
packet delay budget;
number of subchannels;
number of subframes with resource reservations for retransmission or transmission; and/or
resource pool.

3. Transceiver of a wireless communication network, the transceiver being configured to communicate in a sidelink communication;
wherein the transceiver is configured to select, for said sidelink communication, candidate resources out of resources of the sidelink communication by use of a radio resource selection strategy; and
wherein the transceiver is configured to adapt a radio resource selection strategy dependent at least one parameter out of:
battery level and/or battery type of the transceiver;
QoS or priority of the packet to be transmitted;
Load constraints;
Bandwidth part;
resource pool;
characterized in that (i) the candidate resources are calculated by considering prediction functionality; or wherein the candidate resources are calculated by considering prediction functionality and wherein the functionality prediction is based on a geographical location of nearby transceivers.

4. Transceiver of a wireless communication network, the transceiver being configured to communicate in a sidelink communication;
wherein the transceiver is configured to select, for said sidelink communication, candidate resources out of resources of the sidelink communication by use of a radio resource selection strategy; and
wherein the transceiver is configured to adapt a radio resource selection strategy dependent at least one parameter out of:
battery level and/or battery type of the transceiver;
QoS or priority of the packet to be transmitted;
Load constraints;
Bandwidth part;
resource pool;
characterized in that (ii) the candidate resources are calculated by considering prediction functionality; or wherein the candidate resources are calculated by considering prediction functionality and wherein the functionality prediction is based on a geographical location of nearby transceivers, wherein the transceiver is configured to predict resources of the nearby users approaching an area.

5. Transceiver of a wireless communication network, the transceiver being configured to communicate in a sidelink communication;
wherein the transceiver is configured to select, for said sidelink communication, candidate resources out of resources of the sidelink communication by use of a radio resource selection strategy; and
wherein the transceiver is configured to adapt a radio resource selection strategy dependent at least one parameter out of:
battery level and/or battery type of the transceiver;
QoS or priority of the packet to be transmitted;
Load constraints;
Bandwidth part;
resource pool;
characterized in that (iii) the transceiver is configured to use a partial preemption of reserved candidate resources in the frequency domain and/or time domain; or wherein the transceiver is configured to use a partial preemption of reserved candidate resources in the frequency domain and/or time domain when the preemption configured by the higher layer or when the preempting UE's subchannel size is smaller than the preempted UE thereof as per previous preemption procedure or wherein the transceiver is configured to use the remaining radio resource over time/frequency after a partial preemption or wherein the transceiver is configured by the higher layer signaling to use the remaining part of the preempted radio resource over time/frequency domain.

6. Transceiver according to claim 1, wherein the transceiver is configured to perform said sidelink communication using selected candidate resources selected out of a set of candidate resources randomly chosen or a pre-configured or configured part of a resource pool or to use random resource selection in any type of resource pool.

7. Transceiver according to claim 1, wherein the selected and/or adapted resource selection strategy is out of the group comprising:
Random selection of candidates resources without partial sensing or sensing;
Partial sensing-based resource selection, where partial sensing is performed only after resource selection was triggered;
Periodic partial sensing-based resource selection;
Radio resource selection considering prediction functionality, where radio resource selection is based on calculation of the potential candidate resources; and Radio resource selection based on preemption, limiting resource preemption to the portion of required resources.

8. Transceiver according to claim 1, wherein in case of using of random selection of candidate resources the adaption of the radio resource selection strategy comprises an adaption performed with respect to
a defined portion of pre-configured or configured resource pool or a separate specific resource pool or a pre-configured or configured part of a resource pool;
a specific resource pool or a specific resource pool configured based on a geographical area;
a portion of resource pools configured for HARQ or non-HARQ to be used for random resource selection;
a portion of a resource pool exceeding a defined CBR and/or priority and to be used for random resource selection;
an exceptional pool and/or any other type of resource pool;
a specific priority of a part of common/normal/shared RP; and/or
remaining PRBs of a resource pool, the remaining PRBs to be used by the UE with limited battery capacity; or
wherein a subchannel size is configured as the adaption of the radio resource selection strategy.

9. Transceiver according to claim 1, wherein in case of using of radio resource selection based on partial sensing the adaption of the radio resource selection strategy comprises an adaption with regard to at least one out of
partial sensing parameters;
traffic arrivals/flags for triggering the partial sensing;
sensing time instances K;
sensing duration ts;
pr, _pt, where pr is the priority value that is received in in the control information, and pt is the priority of transmission that depends on the application requirements;
packet delay budget;
number of subchannels;
number of subframes with resource reservations for retransmission or transmission; and/or
resource pool.

10. Transceiver according to claim 3, wherein candidate resources are identified based on prediction using the prediction functionality or based on sensing or a combination of prediction functionality and sensing; or
wherein candidate resources are composed of two independent sets wherein a first set is achieved from normal sensing or partial sensing and a second set is a set of candidate radio resources predictively, randomly and/or geographically chosen.

11. Transceiver according to claim 3, wherein in case the set of remaining candidate radio resources is less than a predetermined value, a priority value or another selection threshold value used for the selection of candidate resources is adapted as adaption of a radio resource selection strategy.

12. Transceiver according to claim 4, wherein the transceiver is configured to predict resources of the nearby users approaching an area based on control information broadcasted transmitted by the nearby users; or
wherein the transceiver is configured to predict resources of the nearby users approaching an area based on control information broadcasted transmitted by the nearby users, wherein the control information indicating at least one out of:
Velocity;
Direction;
coordinates;
Velocity class; or
minimum safe relative distance between the UEs.

13. Transceiver according to claim 5, wherein preemption priority level for the transceiver is adapted as adaption of radio resource selection; or
wherein a transceiver having higher preemption priority level is allowed to use PRBs of a transceiver having lower preemption priority level.

14. Transceiver according to claim 5, wherein allowed/enabled/configured or possible preemption is indicated by a control information.

15. Transceiver according to claim 1, wherein the transceiver is configured to receive a control information.

16. Transceiver according to claim 1, wherein the sidelink communication is a new radio, NR, sidelink communication.

17. Transceiver according to claim 1, wherein the transceiver is configured to operate in a new radio, NR, sidelink mode 1 or mode 2.

18. Transceiver according to claim 1, wherein the transceiver is battery operated.

19. Transceiver according to claim 1, wherein the radio resource selection strategy comprises a partial sensing or a periodic partial sensing or a periodic partial sensing, where sensing is performed during sensing occasions and/or a first slot of set of candidate slots is considered as reference point.

20. Vulnerable road user equipment, VRU-UE, comprising a transceiver according to claim 1.

21. Method for communicate in a sidelink communication using a transceiver of a wireless communication network, the method comprising:
selecting, for said sidelink communication, candidate resources out of resources of the sidelink communication by use of a radio resource selection strategy; and
adapting a radio resource selection strategy dependent at least one parameter out of:
battery level and/or battery type of the transceiver;
QoS or priority of the packet to be transmitted;
Load constraints;
Bandwidth part;
resource pool;
characterized in that (i) the transceiver is instructed to select candidate resources randomly from a defined portion of a preconfigured or configured resource pool or a separate specific resource pool or a preconfigured or configured part of a resource pool or to use random resource selection in any type of resource pool; and in that the wherein in case of using of radio resource selection based on random selection the adaption of a radio resource selection strategy comprises an adaption with regard to at least out of
partial sensing parameters;
traffic arrivals/flags for triggering the partial sensing;
sensing time instances K;
sensing duration ts;
pr, _pt, where pr is the priority value that is received in in the control information, and pt is the priority of transmission that depends on the application requirements;
packet delay budget;
number of subchannels;
number of subframes with resource reservations for retransmission or transmission; and/or
resource pool.

22. Method for communicate in a sidelink communication using a transceiver of a wireless communication network, the method comprising:
selecting, for said sidelink communication, candidate resources out of resources of the sidelink communication by use of a radio resource selection strategy; and
adapting a radio resource selection strategy dependent at least one parameter out of:
battery level and/or battery type of the transceiver;
QoS or priority of the packet to be transmitted;
Load constraints;
Bandwidth part;
resource pool;
characterized in that (ii) partial sensing is performed or continuously performed immediate after triggering or after triggering with a delay offset; and/or wherein partial sensing is performed or continuously performed till a first slots of set of candidate slots considering processing time; and in that the wherein in case of using of radio resource selection based on partial sensing the adaption of a radio resource selection strategy comprises an adaption with regard to at least one parameter out of
partial sensing parameters;
traffic arrivals/flags for triggering the partial sensing;
sensing time instances K;
sensing duration ts;
pr, _pt, where pr is the priority value that is received in in the control information, and pt is the priority of transmission that depends on the application requirements;
packet delay budget;
number of subchannels;
number of subframes with resource reservations for retransmission or transmission; and/or
resource pool.

23. Method for communicate in a sidelink communication using a transceiver of a wireless communication network, the method comprising:
selecting, for said sidelink communication, candidate resources out of resources of the sidelink communication by use of a radio resource selection strategy; and
adapting a radio resource selection strategy dependent at least one parameter out of:
battery level and/or battery type of the transceiver;
QoS or priority of the packet to be transmitted;
Load constraints;
Bandwidth part;
resource pool;
characterized in that (i) the candidate resources are calculated by considering prediction functionality; or wherein the candidate resources are calculated by considering prediction functionality and wherein the functionality prediction is based on a geographical location of nearby transceivers.

24. Method for communicate in a sidelink communication using a transceiver of a wireless communication network, the method comprising:
selecting, for said sidelink communication, candidate resources out of resources of the sidelink communication by use of a radio resource selection strategy; and
adapting a radio resource selection strategy dependent at least one parameter out of:
battery level and/or battery type of the transceiver;
QoS or priority of the packet to be transmitted;
Load constraints;
Bandwidth part;
resource pool;
characterized in that (ii) the candidate resources are calculated by considering prediction functionality; or wherein the candidate resources are calculated by considering prediction functionality and wherein the functionality prediction is based on a geographical location of nearby transceivers, wherein the transceiver is configured to predict resources of the nearby users approaching an area.

25. Method for communicate in a sidelink communication using a transceiver of a wireless communication network, the method comprising:
selecting, for said sidelink communication, candidate resources out of resources of the sidelink communication by use of a radio resource selection strategy; and
adapting a radio resource selection strategy dependent at least one parameter out of:
battery level and/or battery type of the transceiver;
QoS or priority of the packet to be transmitted;
Load constraints;
Bandwidth part;
resource pool;
characterized in that (iii) the transceiver is configured to use a partial preemption of reserved candidate resources in the frequency domain and/or time domain; or wherein the transceiver is configured to use a partial preemption of reserved candidate resources in the frequency domain and/or time domain when the preemption configured by the higher layer or when the preempting UE's subchannel size is smaller than the preempted UE thereof as per previous preemption procedure or wherein the transceiver is configured to use the remaining radio resource over time/frequency after a partial preemption or wherein the transceiver is configured by the higher layer signaling to use the remaining part of the preempted radio resource over time/frequency domain.

26. Non-transitory digital storage medium having a computer program stored thereon to perform the method for communicate in a sidelink communication using a transceiver of a wireless communication network, the method comprising:
selecting, for said sidelink communication, candidate resources out of resources of the sidelink communication by use of a radio resource selection strategy; and
adapting a radio resource selection strategy dependent at least one parameter out of:
battery level and/or battery type of the transceiver;
QoS or priority of the packet to be transmitted;
Load constraints;
Bandwidth part;
resource pool;
characterized in that (i) the transceiver is instructed to select candidate resources randomly from a defined portion of a preconfigured or configured resource pool or a separate specific resource pool or a preconfigured or configured part of a resource pool or to use random resource selection in any type of resource pool; and in that the wherein in case of using of radio resource selection based on random selection the adaption of a radio resource selection strategy comprises an adaption with regard to at least out of
partial sensing parameters;
traffic arrivals/flags for triggering the partial sensing;
sensing time instances K;
sensing duration ts;
pr, _pt, where pr is the priority value that is received in in the control information, and pt is the priority of transmission that depends on the application requirements;
packet delay budget;
number of subchannels;
number of subframes with resource reservations for retransmission or transmission; and/or
resource pool,
when said computer program is run by a computer.
